(19) United States
(12) Patent Application Publication
(10) Pub. No.: US 2025/0247744 A1
(43) Pub. Date: Jul. 31, 2025

(54) USER EQUIPMENT DELEGATION SERVICE

(71) Applicant: QUALCOMM Incorporated, San Diego, CA (US)

(72) Inventors: Aziz GHOLMIEH, Del Mar, CA (US); Rajeev KUMAR, San Diego, CA (US)

(21) Appl. No.: 18/429,145

(22) Filed: Jan. 31, 2024

(51) Int. Cl. H04W 28/18; H04W 4/20; H04W 4/50

(52) U.S. Cl. CPC H04W 28/18; H04W 4/20; H04W 4/50

(57) ABSTRACT

Methods, systems, and devices for wireless communications are described. A user equipment (UE) delegation service may obtain a service management message from a first device in a wireless network. The service management message may authorize the UE delegation service to negotiate a service configuration on behalf of the first device. Thus, the UE delegation service may communicate with one or more service modules on the behalf of the first device based on the service management message.

### INTRODUCTION

The following relates to wireless communications, and more specifically to the implementation of a user equipment (UE) delegation service.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as UE (UE).

### SUMMARY

The described techniques relate to improved methods, systems, devices, and apparatuses that supports a UE delegation service. For example, the described techniques provide for a UE delegation service obtaining (e.g., receiving) a service management message from a first device in a wireless network (e.g., a UE). In some examples, the service management message may authorize the UE delegation service to negotiate a service configuration on behalf of the first device. Further, the UE delegation service may communicate with one or more service modules on behalf of the first device based on the UE delegation service obtaining the service management message.

A method for wireless communications by a UE delegation service is described. The method may include obtaining a service management message authorizing the UE delegation service to negotiate a service configuration on behalf of a first device in a wireless network and communicating, with one or more service modules, on the behalf of the first device based on the service management message.

A UE delegation service for wireless communications is described. The UE delegation service may include one or more memories storing processor executable code, and one or more processors coupled with the one or more memories. The one or more processors may individually or collectively operable to execute the code to cause the UE delegation service to obtain a service management message authorizing the UE delegation service to negotiate a service configuration on behalf of a first device in a wireless network and communicate, with one or more service modules, on the behalf of the first device based on the service management message.

Another UE delegation service for wireless communications is described. The UE delegation service may include means for obtaining a service management message authorizing the UE delegation service to negotiate a service configuration on behalf of a first device in a wireless network and means for communicating, with one or more service modules, on the behalf of the first device based on the service management message.

A non-transitory computer-readable medium storing code for wireless communications is described. The code may include instructions executable by one or more processors to obtain a service management message authorizing the UE delegation service to negotiate a service configuration on behalf of a first device in a wireless network and communicate, with one or more service modules, on the behalf of the first device based on the service management message.

Some examples of the method, UEs, and non-transitory computer-readable medium described herein may further include operations, features, means, or instructions for obtaining, from the first device in the wireless network, the service management message, the service management message updating the UE delegation service with a status of the first device and one or more dynamic preferences of the first device.

Some examples of the method, UEs, and non-transitory computer-readable medium described herein may further include operations, features, means, or instructions for outputting, to the first device in the wireless network, the service management message, the service management message updating or affecting a status of the first device and one or more dynamic preferences of the first device based on communication with the one or more service modules.

Some examples of the method, UEs, and non-transitory computer-readable medium described herein may further include operations, features, means, or instructions for outputting, or obtaining, a service configuration request that requests an establishment of a service associated with the first device and communicating, with at least one service module of the one or more service modules, one or more service configuration messages to negotiate, with the at least one service module, the service configuration of the service for the first device based on the service configuration request, the service management message, or both.

Some examples of the method, UEs, and non-transitory computer-readable medium described herein may further include operations, features, means, or instructions for communicating one or more messages to negotiate one or more parameters of the service configuration and obtaining, from a second device in the wireless network, the service configuration based on the one or more messages, where the second device may be a network entity of a radio access network (RAN).

Some examples of the method, UEs, and non-transitory computer-readable medium described herein may further include operations, features, means, or instructions for determining, at the UE delegation service, one or more parameters of the service configuration for the first device and communicating, with the one or more service modules, one or more messages that include the one or more parameters of the service configuration for the first device.

Some examples of the method, UEs, and non-transitory computer-readable medium described herein may further include operations, features, means, or instructions for obtaining, from at least one service module of the one or more service modules, a service configuration request and communicating one or more messages to negotiate one or more parameters of the service configuration on the behalf of the first device based on the service management message, the service configuration request, or both.

Some examples of the method, UEs, and non-transitory computer-readable medium described herein may further include operations, features, means, or instructions for outputting, to a second device in the wireless network, a configuration preference request message, obtaining, from the second device, an indication of one or more configuration preferences for the service configuration based on the configuration preference request message, and communicating the one or more messages to negotiate the one or more parameters of the service configuration on the behalf of the first device based on the service management message, the service configuration request, the one or more configuration preferences from the second device, or any combination thereof.

Some examples of the method, UEs, and non-transitory computer-readable medium described herein may further include operations, features, means, or instructions for obtaining, from the first device, a service request message that requests establishment of one or more services associated with the first device, outputting, to the one or more service modules, one or more service configuration request messages based on the one or more service configuration request messages from the first device, obtaining, from the one or more service modules, one or more service configuration response messages, and communicating one or more messages to negotiate one or more parameters of the service configuration on the behalf of the first device based on the service management message, the one or more service configuration response messages, or both.

Some examples of the method, UEs, and non-transitory computer-readable medium described herein may further include operations, features, means, or instructions for outputting, to a second device in the wireless network, a configuration preference request message, obtaining, from the second device, an indication of one or more configuration preferences for the service configuration, and communicating the one or more messages to negotiate the one or more parameters of the service configuration on the behalf of the first device based on the service management message, the one or more service configuration response messages, the one or more configuration preferences from the second device, or any combination thereof.

Some examples of the method, UEs, and non-transitory computer-readable medium described herein may further include operations, features, means, or instructions for obtaining a list of the one or more services with which the first device may be requesting to establish a service.

Some examples of the method, UEs, and non-transitory computer-readable medium described herein may further include operations, features, means, or instructions for obtaining a respective service configuration response message of the one or more service configuration response messages from a respective service module of the one or more service modules that indicates a service profile of the respective service module, capability information of the respective service module, one or more configuration preferences for the respective service module, or any combination thereof.

Some examples of the method, UEs, and non-transitory computer-readable medium described herein may further include operations, features, means, or instructions for obtaining, from the one or more service modules, one or more service configuration feasibility request messages and outputting, to the one or more service modules, one or more service configuration feasibility response messages, the one or more service configuration feasibility response messages indicating whether the service configuration between a respective service module of the one or more service modules and the first device may be feasible.

Some examples of the method, UEs, and non-transitory computer-readable medium described herein may further include operations, features, means, or instructions for obtaining, from the first device, a service request message that requests establishment of one or more services associated with the first device, outputting, to the one or more service modules, a service configuration request message, and communicating one or more messages to negotiate one or more parameters of the service configuration on the behalf of the first device based on the service request message.

Some examples of the method, UEs, and non-transitory computer-readable medium described herein may further include operations, features, means, or instructions for outputting, to the first device, a device management message indicating one or more machine learning models.

Some examples of the method, UEs, and non-transitory computer-readable medium described herein may further include operations, features, means, or instructions for obtaining, from a second device in the wireless network, a UE configuration feasibility request message and outputting, to the second device, a UE configuration feasibility response message, the UE configuration feasibility response message indicating whether the service configuration between the second device and the first device may be feasible.

In some examples of the method, UEs, and non-transitory computer-readable medium described herein, the one or more service modules may include a first service module and a second service module and the method, apparatuses, and non-transitory computer-readable medium may include further operations, features, means, or instructions for monitoring performance of the first device, outputting, to the one or more service modules, a first report based on the performance of the first device, a second report based on the performance of the first device, to a second device in the wireless network, or outputting both the first report and the second report, where the first report corresponds to the first service module and the second report corresponds to the second service module, outputting, or obtaining, a reconfiguration message to reconfigure the service configuration on the behalf of the first device, where the reconfiguration message may be outputted, or obtained, based on the performance of the first device satisfying a performance threshold, and communicating one or more messages to renegotiate one or more parameters of the service configuration on the behalf of the first device based on the reconfiguration message and the performance of the first device satisfying the performance threshold.

In some examples of the method, UEs, and non-transitory computer-readable medium described herein, the first device may be one of a plurality of devices in the wireless network and the method, apparatuses, and non-transitory computer-readable medium may include further operations, features, means, or instructions for receiving a set of multiple service management message authorizing the UE delegation service to negotiate the service configuration on the behalf of the set of multiple devices.

Some examples of the method, UEs, and non-transitory computer-readable medium described herein may further include operations, features, means, or instructions for obtaining the service management message via a communication interface between the first device and the UE delegation service.

Some examples of the method, UEs, and non-transitory computer-readable medium described herein may further include operations, features, means, or instructions for obtaining, via a communication interface between the first device and the UE delegation service, device management information including a report of one or more statistics of the first device, information associated with one or more machine learning models, information associated with downloading the one or more machine learning models, or any combination thereof.

### BRIEF DESCRIPTION OF THE DRAWINGS

FIG. 1 shows an example of a wireless communications system that supports a UE delegation service in accordance with one or more aspects of the present disclosure.

FIG. 2 shows an example of a network architecture that supports a UE delegation service in accordance with one or more aspects of the present disclosure.

FIG. 3 shows an example of a wireless communications system that supports a UE delegation service in accordance with one or more aspects of the present disclosure.

FIGS. 4 through 11 show examples of process flows that supports a UE delegation service in accordance with one or more aspects of the present disclosure.

FIGS. 12 and 13 show block diagrams of devices that support a UE delegation service in accordance with one or more aspects of the present disclosure.

FIG. 14 shows a block diagram of a communications manager that supports a UE delegation service in accordance with one or more aspects of the present disclosure.

FIG. 15 shows a diagram of a system including a device that supports a UE delegation service in accordance with one or more aspects of the present disclosure.

FIGS. 16 through 18 show flowcharts illustrating methods that support a UE delegation service in accordance with one or more aspects of the present disclosure.

### DETAILED DESCRIPTION

In some examples, when configuring a user equipment (UE) (e.g., a first wireless device), a network entity (e.g., a second wireless device, a radio access network (RAN)) may communicate multiple messages over-the-air with the UE via a wireless communication link. For example, when deploying a UE, the UE may establish a wireless connection with a network entity for wireless communications. To establish the wireless connection, the UE and the network entity may communicate multiple over-the-air messages to coordinate the parameters of the wireless connection based on the capabilities of the UE, the capabilities of the network entity, or both. Further, such over-the-air communications may be relatively time consuming and can consume valuable wireless communication resources. For example, the round-trip time (RTT) of communications between a UE and a network entity may be relatively high and the UE and network entity may have to consume resources to encode messages to be transmitted, decoded received messages, or both. Thus, when the UE and network entity transmit multiple over-the-air messages to establish connections between the UE and a respective service, the latency of the over-the-air messaging may be relatively high and the quantity of computational resources to encode/decode messages can increase accordingly For example, in wireless communications (e.g., 5G communications, sixth generation (6G) communications, or a combination thereof) a UE and a network entity may concurrently configure (e.g., establish connections with) multiple services (e.g., mobility, admission control, resource reservation, subscription checks, or any combination thereof) with the UE.

As described herein, a service may be hosted at one or more components of a cloud-based network, where the components of each service may be associated with a respective network address. The respective one or more services may be provided by network providers, network entities, UEs, third-party entities, etc., where each service is configured to support a respective service or functionality offered to the UE, the network entity, and so on. Thus, due to an increase in a quantity of services that the UE may establish connections with (e.g., be configured with), the wireless communication system may experience an increase in latency related to the UE establishing wireless connections with the network entity, one or more service, or both.

Accordingly, techniques described herein may establish a UE delegation service hosted at one or more components of a network (e.g., within a network entity, a cloud-based platform, or a combination thereof) to negotiate on the behalf of UEs to reduce the latency of establishing connections between the UE and a network entity, one or more services, or both. According to one aspect, the UE delegation service that is hosted on the network may be configured to negotiate a service configuration on behalf of a UE or a group of UEs (e.g., a wireless device or a group or wireless devices). As described herein, a delegation service (e.g., the UE delegation service) may be a service hosted at one or more components of a cloud-based network, that is configured to act on the behalf of another service or device. The UE delegation service may be an example of a delegation service that is configured (e.g., established with instructions) to communicate to the network entity, one or more services, or both in place of the UE. To enable a delegation service to act on the behalf of a device, the device (e.g., UE) may transmit an initial authorization message to the delegation service.

Further, a negotiation of a service configuration may include the UE delegation service transmitting the capabilities and preferences of a UE to the network entity, the one or more services, or both and receiving the capabilities and preferences of the network entity, the one or more services, or both. As a result, the UE delegation service and the network entity, the one or more services, or both may coordinate on establishing a set of parameters for a wireless connection that is in accordance with the capabilities of the UE, the network entity, the one or more services, or any combination thereof. Therefore, to negotiate on behalf of a UE, the UE delegation service may communicate the capabilities and preferences of the UE to the network entity, the one or more services, or both, thus enabling the UE the capability of refraining from transmitting such information over-the-air.

In some examples, the UE delegation service may receive, a message from a first device (e.g., a UE) that authorizes the UE delegation service to negotiate a service configuration on behalf of the first device. The service configuration may be the configuration that establishes a connection between the first device and a respective service. Additionally, or alternatively, the message may be a service management message that indicates information that enables the UE delegation service to negotiate the service configuration on behalf of the first device. Moreover, the information that enables the UE delegation service to negotiate the service configuration on behalf of the first device may also authorize the UE delegation service to operate on behalf of the first device. For example, the information may include the credentials of the first device to enable the UE delegation service the capability to access information related to the first device.

Additionally, or alternatively, the UE delegation service may communicate, with one or more service modules, on behalf of the first device based on the first device authorizing the UE delegation to do so. Further, the one or more service modules may correspond to one or more services within the network that the UE may establish a service or connection with. Thus, the UE delegation service may negotiate the service configuration for a UE with the network entity and the one or more service modules to enable the network entity and the respective service modules the capability of refraining from transmitting configuration messages over-the-air to the UE. A configuration message may be a message that includes one or more parameters of a wireless connection. Therefore, the network entity and the one or more service modules may negotiate the service configuration with the UE delegation service instead of negotiating the service configuration with the UE. Thus, use of the UE delegation service may result in a decrease in the quantity of over-the-air messaging for configuring the UE with the service configuration. For example, since the UE delegation service is hosted on the network, the UE delegation service may communicate with the network entity or one or more services that are hosted on the network via connections within the network, resulting in a decrease of configuration messaging being communicated over-the-air. Further, the RTT of network communications may be relatively less than the RTT of communications over-the-air between the UE and the network. Therefore, due to decrease in the RTT, the wireless communications system may experience a decrease in latency when establishing connections between the UE and the network entity, the one or more services, or both, thus resulting in an increase in efficiency and reliability within the wireless communications system.

Alternatively, or additionally, the UE delegation service may maintain updated information on the status and preferences of a UE such that the UE delegation service can accurately and efficiently negotiate the service configuration on behalf of the UE. Moreover, the preferences may include one or more dynamic preferences that are updated based on the status of the UE. For example, if a UE is in a power savings mode, the status of a UE may be whether the UE is within the power savings mode and the preferences of the UE may be a set of parameters that when used may enhance the power savings of the UE or are used to enhance the performance of the UE. Further, by maintaining the current status and preferences of the UE, the UE delegation service may be capable of negotiating on behalf of the UE in accordance with the most up-to-data information of the UE. Additionally or alternatively, the UE delegation service may initiate an additional service configuration or respond to a request for an additional service configuration on behalf of the UE. For example, the UE delegation service may transmit or receive a service configuration request that is a message that requests an connection to be established between a service and a UE. Further, the service management message may update or affect the status of a UE due to an increase in wireless connections, thus receiving up-to-date information may improve subsequent connection establishments.

In some examples, the UE delegation service may also obtain feasibility request messages from one or mor service modules to determine whether a service configuration is feasible. For example, before configuring a UE with a service configuration to establish a connection between a first service and the UE, the first service may transmit one configuration feasibility request messages to the UE delegation service to determine the feasibility of the service configuration. Thus, the UE delegation service may transmit or output one or more configuration feasibility response messages to the first service to indicate whether the service configuration is feasible. For a service configuration to be feasible, the service configuration may be in accordance with the current status and preferences of the UE and the service that the UE is establishing a connection with. Thus, feasible service configurations are able to be used by both the UE and the service that is being connected to the UE.

Moreover, the UE delegation service may transmit one or more reports about the performance of a UE to the network entity, the one or more service modules, or both. The reports may enable the network entity, the one or more service modules, or both the capability of determining if the UE should be reconfigured. Therefore, in some examples, based on the performance of the UE indicated within the one or more reports, the UE delegation service may transmit or receive a reconfiguration message to reconfigure the service configuration of the UE.

Additionally, or alternatively, the UE delegation service may validate the proposed UE service configurations and negotiate with the network entity and the one or more service modules on the network to obtain acceptable, efficient, and reliable configurations. For example, the UE delegation service may use the status and preferences of the UE to determine if a UE service configuration is in accordance with the preferences of the UE and the UE is capable of using the UE service configuration. Therefore, the UE delegation service may have the capability to ensure that the UE receives an accurate, efficient, and reliable configuration by maintaining up-to-date information about the UE while reducing the delay related to negotiating the UE service configuration by performing at least a portion of the negotiation within the network thus reducing the quantity of over-the-air messaging, thus resulting in a more efficient and reliable wireless communications system.

Aspects of the disclosure are initially described in the context of wireless communications systems. Additional aspects of the disclosure are described with reference to a wireless communications system and process flows. Aspects of the disclosure are further illustrated by and described with reference to apparatus diagrams, system diagrams, and flowcharts that relate to UE delegation service.

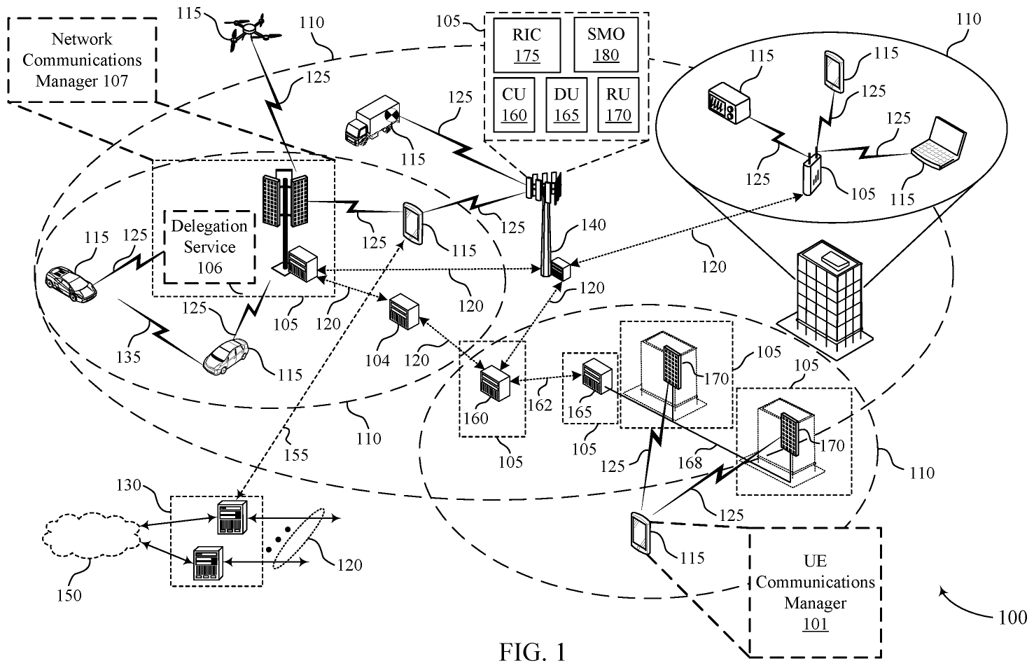

FIG. 1 shows an example of a wireless communications system 100 that supports a UE delegation service in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

In some examples, one or more UEs 115 and network entities 105 may communicate via UE communications managers 101 and network communications managers 107. For example, a UE 115 may include a UE communications manager 101, which may be an example of communications managers as described herein. The UE 115 may, via the UE communications manager 101, register a list of services provided by the UE 115 and/or service preference information for the UE 115. A network entity 105 may include a network communications manager 107, which may be an example of communication managers as described herein. The network entity 105 may, via the network communications manager 107, receive the list of services and/or the service preference information (e.g., from the UE 115 or from another entity, such as a delegation service 106). The network entity 105 may configure the UE 115 with one or more services based on the service information via the network communications manager 107.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, the wireless communications system 100 may include a delegation service 106 (e.g., a UE delegation service) that may perform one or more operations to facilitate registration of service preferences and capabilities for entities in the wireless communications system 100. For example, the delegation service 106 may include a communications manager (e.g., a network communications manager 107) that may allow the delegation service 106 to manage a list of services provided by a UE 115 and one or more service preferences of the UE 115 or one or more other entities (e.g., network entities 105) in the wireless communications system 100. In some examples, the delegation service 106 may co-located with one or more other network entities 105 (e.g., RAN nodes, other network-provided services) as illustrated with reference to FIG. 1. In some examples, the delegation service 106 may be a separate entity in the wireless communications system 100.

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support UE delegation service as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Techniques described herein, in addition to or as an alternative to be carried out between UEs 115 and base stations 105, may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 175 is flexible and as such gives rise to numerous permutations of different functionalities depending upon which functions (e.g., MAC functions, baseband functions, radio frequency functions, and any combinations thereof) are performed at the CU 160, DU 165, and RU 175. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more base stations 105 may include CUs 160, DUs 165, and RUs 170 and may be referred to as donor base stations 105 or IAB donors. One or more DUs 165 (e.g., and/or RUs 170) associated with a donor base station 105 may be partially controlled by CUs 160 associated with the donor base station 105. The one or more donor base stations 105 (e.g., IAB donors) may be in communication with one or more additional base stations 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of base stations 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a base station 105 may additionally or alternatively be performed by components of the disaggregated RAN architecture (e.g., IAB nodes, DUs, CUs, etc.).

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Certain aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. ML models may be deployed in one or more devices (for example, network entities and user equipments (UEs)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML model,” “ANN,” “model,” “algorithm,” or the like are intended to be interchangeable.

In some examples of the wireless communications system 100, when configuring a UE 115 (e.g., a first wireless device), a network entity 105 (e.g., a second wireless device, a RAN, or any combination thereof) may communicate multiple messages over-the-air with the UE 115 via a wireless communication link (e.g., a communication link 125). Such communications may be relatively time consuming and consume valuable wireless communication resources. For example, in 6G communications, a UE 115 and a network entity 105 may concurrently configure multiple services (e.g., mobility, admission control, resource reservation, subscription checks, or any combination thereof) with the UE 115, resulting in a relatively large volume of over-the-air messaging. Further, such over-the-air messaging may result in an increase in delay within the wireless communications system 100.

Thus, a UE delegation service hosted on the network may be configured to negotiate a service configuration on behalf of a UE 115 or a group of UEs 115 (e.g., a wireless device or a group or wireless devices). For example, the UE delegation service may negotiate the service configuration for a UE 115 with the network entity 105 and one or more service modules to prevent the network entity 105 and the respective service modules from transmitting configuration messages over-the-air to the UE 115. Therefore, the network entity 105 and the one or more service modules may negotiate the service configuration with the UE delegation service instead of with the UE 115. Thus, the UE delegation service may enable a decrease in the quantity of over-the-air messaging for configuring the UE 115 with the service configuration.

Further, in some examples, the UE delegation service may maintain updated information on the status and preferences of the UE 115 such that the UE delegation service can accurately and efficiently negotiate the service configuration on the behalf of the UE 115. The UE delegation service may also initiate an additional service or respond to a request for an additional service on the behalf of the UE 115. Additionally, or alternatively, the UE delegation service may validate the proposed UE 115 service configurations and negotiate with the network entity 105 and the one or more service modules on the network to obtain an acceptable, efficient, and reliable configuration. Therefore, the UE delegation service may be capable of ensuring the UE 115 receives an accurate, efficient, and reliable configuration while reducing the delay related to negotiating the UE service configuration by preventing excessive over-the-air messaging, thus resulting the wireless communications system 100 being more efficient and reliable.

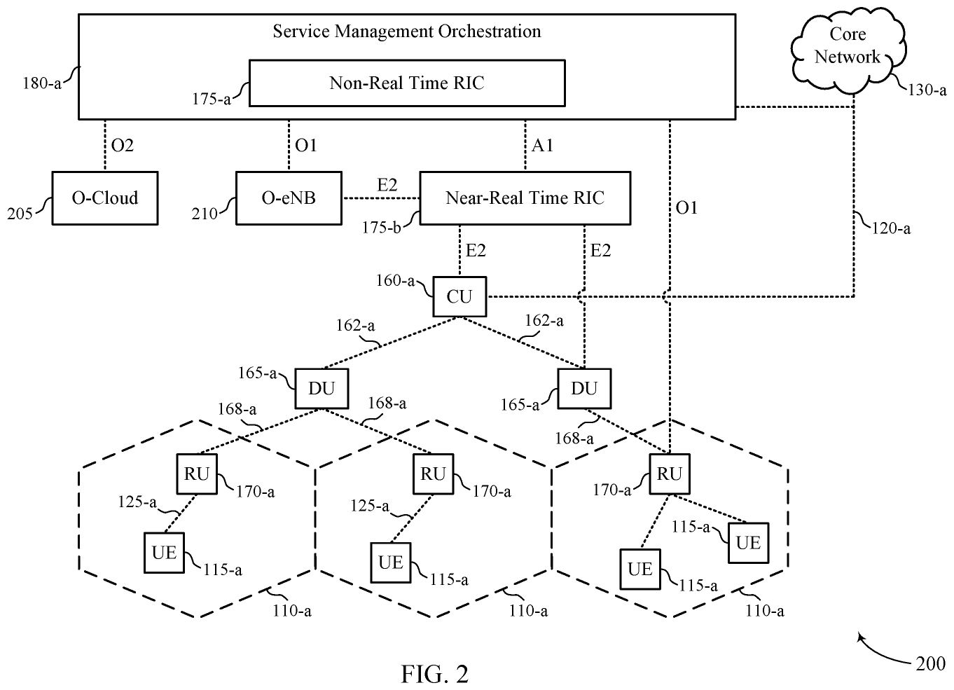

FIG. 2 shows an example of a network architecture 200 (e.g., a disaggregated base station architecture, a disaggregated RAN architecture) that supports a UE delegation service in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (IFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an Al interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-NB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., Al policies).

In some examples, when configuring a UE 115-a (e.g., a first wireless device), a network entity 105 (e.g., a second wireless device, a RAN, a DU 165-a, a RU 170-a, or any combination thereof) may communicate multiple messages over-the-air with the UE 115-a via a wireless communication link (e.g., a communication link 125-a). Such communications may be relatively time consuming and consume valuable wireless communication resources. For example, in 6G communications, a UE 115-a and a network entity 105 may concurrently configure multiple services (e.g., mobility, admission control, resource reservation, subscription checks, or any combination thereof) with the UE 115-a, resulting in a relatively large volume of over-the-air messaging. Further, such over-the-air messaging may result in an increase in delay within the wireless communications system 100.

Thus, a UE delegation service hosted on the network may be configured to negotiate a service configuration on behalf of a UE 115-a or a group of UEs 115 (e.g., a wireless device or a group or wireless devices). For example, the UE delegation service may negotiate the service configuration for a UE 115-a with the network entity 105 and one or more service modules to prevent the network entity 105 and the respective service modules from transmitting configuration messages over-the-air to the UE 115-a. Therefore, the network entity 105 and the one or more service modules may negotiate the service configuration with the UE delegation service instead of with the UE 115-a. Thus, the UE delegation service may enable a decrease in the quantity of over-the-air messaging for configuring the UE 115-a with the service configuration.

Further, in some examples, the UE delegation service may maintain updated information on the status and preferences of the UE 115-a such that the UE delegation service can accurately and efficiently negotiate the service configuration on the behalf of the UE 115-a. The UE delegation service may also initiate an additional service or respond to a request for an additional service on the behalf of the UE 115-a. Additionally, or alternatively, the UE delegation service may validate the proposed UE 115-a service configurations and negotiate with the network entity 105 and the one or more service modules on the network to obtain an acceptable, efficient, and reliable configuration. Therefore, the UE delegation service may be capable of ensuring the UE 115-a receives an accurate, efficient, and reliable configuration while reducing the delay related to negotiating the UE service configuration by preventing excessive over-the-air messaging, thus resulting in a more efficient and reliable wireless communications system.

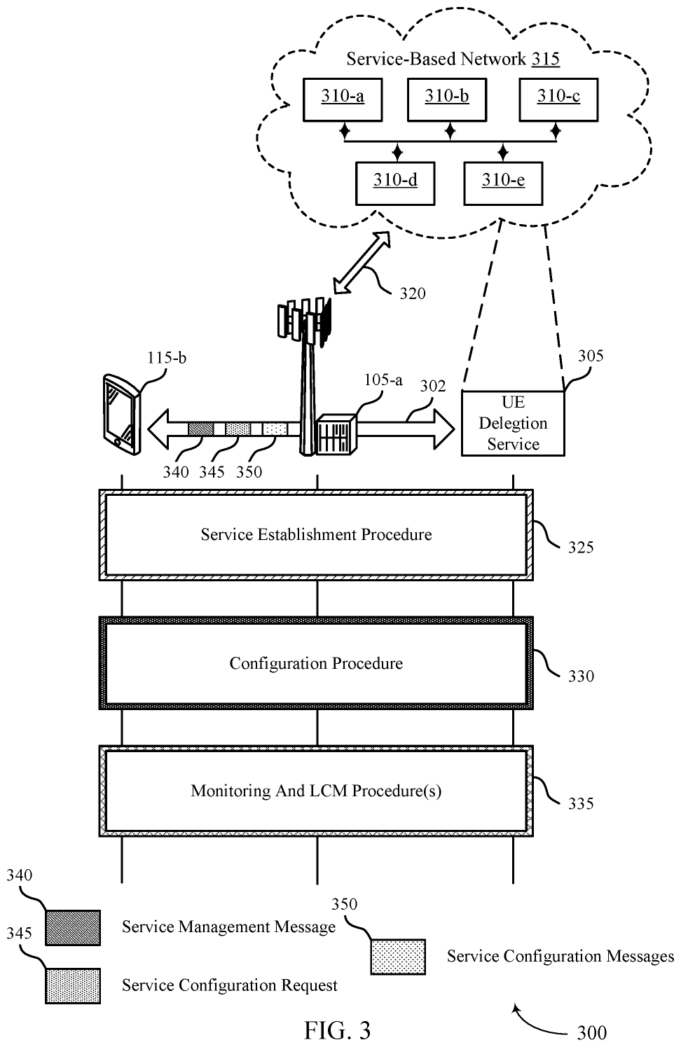

FIG. 3 shows an example of a wireless communications system 300 that supports a UE delegation service in accordance with one or more aspects of the present disclosure. In some examples, the wireless communications system 300 may implement or be implemented by aspects of the wireless communications system 100, the network architecture 200, or both. The wireless communications system 300 may include a UE 115-b and a network entity 105-a, which may be examples of the corresponding devices as described with respect to FIG. 1. In some examples, the UE 115-b may refer to one or more UEs 115 or a group of UEs 115. In some implementations, the network entity 105-a may refer to one or more network entities 105 or a group of network entities 105. In some implementations, the network entity 105-a may refer to a RAN of one or more network entities 105. The wireless communications system may also include a UE delegation service 305 in communication with both the network entity 105-a and the UE 115-b. Further, in some examples, the UE 115-b may communicate with the UE delegation service 305 via a communication interface 302.

In some examples, the UE delegation service 305 may be one of a set of services 310 within a service-based network 315. Therefore, the UE delegation service 305 may be a part of the service-based network 315. In some other examples, the UE delegation service 305 may be separate from the service-based network 315 and the UE delegation service may communicate with the service-based network 315. The set of services 310 in the service-based network 315 may include a service 310-a, a service 310-b, a service 310-c, a service 310-d, a service 310-e, or any combination thereof. The services 310 may communicate with the network entity 105-a via a communication link 320. Additionally, or alternatively, the communication link 320 may be an example of a backhaul link.

In some examples, the network entity 105-a may be configured to connect the UE 115-b to the one or more services 310 (e.g., network services) of the service-based network 315. In particular, the network entity 105-a may relay communications between the UE 115-b and the one or more various services 310 of the service-based network 315 via one or more communication links 320. Such communications may enable the UE 115-b to establish and maintain wireless connections with the respective one or more services 310 in order to exchange communications associated with the various functionalities that are supported by the respective one or more services 310. In other words, the wireless communications system 300 may enable the UE 115-b to “subscribe” to the respective one or more services 310 on an à la carte basis depending on the needs or requirements of the UE 115-b. In this regard, different UEs 115 within the wireless communications system 300 may be able to subscribe to different subsets of one or more services 310 depending on the capabilities of the UEs 115, applications executed at the UEs 115, a mobility of the UEs 115, or any combination thereof.

Each service 310 may be associated with a respective network address within the service-based network 315. Stated differently, each service 310 may be hosted at one or more components of a cloud-based network, where the components of each service 310 may be associated with a respective network address. The respective one or more services 310 may be provided by network providers, third-party entities, or any other type of wireless communication provider. Further, the configuration of each service 310 may support a respective service or functionality offered to the components of the wireless communications system 300 (e.g., the UE 115-b, the network entity 105-a, or both).

Different services, functionalities, and functions that are supported or offered by the respective services 310 may include, but are not limited to, a mobility service 310, a security service 310, a privacy service 310, a location service 310, an admission control service 310, a resource reservation service 310, a subscription check service 310, or any combination thereof. In other words, a service 310 may refer to any of one or more services provided to the UE 115-b, the network entity 105-a, or both. In some implementations, the service 305 may be an AI, ML, or AI and ML (AI/ML) service. Further, the respective services 310 may also be referred to as service modules elsewhere herein.

Some wireless communications systems (e.g., the wireless communications system 300) may support non-transparent cross-node procedures. In some examples, non-transparent procedures may include procedures where the UE 115-a connects directly to a service 305 (e.g., a cross-node AI/ML service). In some examples, non-transparent cross-node procedures may include a service establishment procedure 325, a configuration procedure 330, one or more monitoring and LCM procedures 335, or any combination thereof.

In some examples, the UE 115-b may discover an available service 310 in the service establishment procedure 325. Additionally, or alternatively, UE 115-b may establish a connection with the service 310 during the service establishment procedure 325. In some examples, the service establishment procedure 325 may include a capability exchange.

In some implementations, the network entity 105-a or the UE delegation service 305 may transmit configuration signaling to the UE 115-b during the configuration procedure 330. For example, the configuration procedure 330 may be a cross-node AI/ML configuration procedure. In some examples, the service 310 may transmit signaling to configure the UE 115-b for AI/ML procedures. In some examples, the service 305 may configure the UE 115-b and the network entity 105-a (e.g., to perform the configuration procedure). Additionally, or alternatively, the network entity 105-a may provide additional configuration signaling to the UE 115-b, the services 310, or both. For example, the network entity 105-a may provide lower layer configuration signaling. Additionally, or alternatively, the network entity 105-a may configure an interface for the UE 115-b (e.g., an air interface, Uu link, access link, etc.). For example, the network entity 105-a may transmit an indication of a configuration of the interface for the UE 115-b to perform the configuration procedure 210.

In some examples, the UE 115-b, the network entity 105-a, the services 310, or any combination thereof may monitor input signaling during the monitoring and LCM procedure(s) 335. In some examples, the LCM procedure 335 may be based on the output of the monitoring by the UE 115-b, the network entity 105-a, the services 310, or any combination thereof. In some examples, the LCM procedure(s) 335 may include activate, deactivate, fallback, switch, or reconfigure procedures.

Further, in some examples of the wireless communications system 300, the wireless communications system 300 may be configured with multiple services 310 that can perform the same functionality. Therefore, the wireless communications system 300 may use a selection process or some selection logic to determine which service 310 to use. Additionally, or alternatively, the network entity 105-a (e.g., a gNB for a RAN or an AMF for the core network) may collect the capabilities of the UE 115-b to implement a logic to select a service 310 based on both the capabilities of the network and the UE 115-b. In some examples, the network may have a cloud native architecture where functions are delegated to services 310 in a decentralized manner. In some examples, the decentralized logic may be useful and subject to additional internal work for the network. In some other examples, a centralized logic can recreate the gNB or AMF and similar nodes. Further, the network may also use end-to-end decision making per service 310 or function.

In future generations of wireless communications (e.g., 6G), the development of lighter protocols where each function may be separated into a lighter protocol stack may be useful. For example, by separating functions into lighter protocol stacks, modular protocols may be created that can be put together to serve multiple applications. Such use of modular protocols may be more efficient than some fixed devices or for eMBB devices that may use a full set of functionalities, lower throughput, higher latencies, or both. Further, satellite-based communications and unlicensed spectrums may expect to use overlapping sets of functionalities. Moreover, by splitting functions into separate lighter protocols, there may be multiple parallel or sequential interactions with multiple network entities 105 to achieve the same configuration or results.

Additionally, or alternatively, when a UE 115 (e.g., the UE 115-b) moves to a different RAT, cell, or frequency, the UE 115-b may expect to be configured with one or more services 310 or functionalities. For example, the UE 115-b may expect to be configured with one or more services 310 or functionalities for mobility, admission control, resource reservation, subscription checks, or any combination thereof. In some examples, the one or more services 310 may also interact or communicate between each other. For example, the service 310-a may interact or communicate with the service 310-b, and vice versa. Additionally, or alternatively, the service 310-a may communicate with the service 310-b where the service 310-b is dependent on the service 310-a. In some examples, the service 310-a may be considered a parent service 310 and the service 310-b may be considered a child service 310 (e.g., a child service 310 of the parent service 310-a). Further the service 310-b may be unable to function without the service 310-a as the service 310-b depends on one or more functionalities of the service 310-a. However, the service 310-a may be capable of functioning separate from the service 310-b. Additionally, or alternatively, the service 310-a and the service 310-b may be linked together and may be unable to function separately. Further some services 310 such as AI/ML services 310, may use UE 115 proprietary information (e.g., one or more UE 115 memories, processing power from one or more processors, or both used collectively or individually), to determine the configuration of the UE 115-b.

Additionally, or alternatively, when UEs 115 (e.g., the UE 115-b) move between RATs, cells, or frequencies, the configuration of the UE 115-b may change. Further, while some services 310 may be unaffected by mobility and are self-contained (e.g., independent from mobility changes), some services 310 are dependent on physical layer resources and on other services 310 that are different in different RATs, cells, or frequencies. Thus, some services 310 may perform one or more negotiations and with the UE 115-b to configure or reconfigure the connection between a respective service 310 and the UE 115-b. In some examples, it may be beneficial for an entity (e.g., a wireless device or a service 310) that is capable of aggregating information from the UE 115-b, the network entity 105-a, and the one or more services 310 within the service-based network 315, to make one or more configuration decisions based on the aggregated information.

For example, to perform such negation and renegotiation procedures the services 310 and the network entity 105-a may transmit multiple over-the-air messages to the UE 115-b. That is, each respective service 310 may transmit one or more messages to the UE 115-b via a communication link which may result in a relatively high signaling overhead that can cause an increase in delay within the wireless communications system 300. Therefore, having a representation of the UE 115-b alongside the network entity 105-a and the service-based network 315 may be useful to reduce the quantity of over-the-air messaging. However, having a complex representation of the one or more memories of the UE 115-b, the one or more processors of the UE 115-b (e.g., the UE 115-b processing capabilities), the one or more accelerators of the UE 115-b (e.g., CPUs, GPUs, VPUs, or any other device or service used to accelerate the processing of the UE 115-b), or any combination thereof, may be unfeasible in some situations or conditions. Further, the creation and management of such representation may reduce the quantity of computing resources available to other wireless devices (e.g., the network entity 105-a, the UE 115-b, or both).

Therefore, in accordance with one or more aspects of the present disclosure, a service (e.g., the UE delegation service 305) may be created or generated on the network to be a representation of the UE 115-b. In some examples, the UE delegation service 305 may be connected to, generated by, or in communication with the core network of the network entity 105-a, the service-based network 315 such that the UE delegation service 305 is available on the network to the network entity 105-a and the service-based network 315. Moreover, the UE delegation service 305 may be a service that can act and respond on behalf of the UE 115-b. For example, the UE delegation service may obtain, from the UE 115-b, a service management message 340 authorizing the UE delegation service 305 to negotiate a service configuration on behalf of the UE 115-b (e.g., a first device in a wireless network). Additionally, or alternatively, the UE delegation service 305 may obtain the service management message 340 via the communication interface 302 between the UE 115-b and the UE delegation service 305.

Thus, the UE delegation service may communicate with one or more service modules on behalf of the first device (e.g., the UE 115-b) based on the service management message 340. Further, in some examples, the UE 115-b may be a first device of a set of devices in a wireless network and the UE delegation service 305 may obtain a set of service management messages 340 that authorize the UE delegations service 305 to negotiate the service configuration on the behalf of the set of devices. In addition, obtaining the service management message 340 may include obtaining, via the communication interface 302 between the UE 115-b and the UE delegations service 305, device management information. The device management information may include a report of one or more statistics of the UE 115-b, information associated with one or more machine learning (ML) models (e.g., ML or artificial intelligence (AI) models (AI/ML models)), information associated with downloading the one or more ML models, or any combination thereof. Additionally, or alternatively, the UE delegation service 305 may be an example of a service 310 within the service-based network 315 or a service that is separate from the one or more services service 310 in the service-based network 315.

In some examples, the UE delegation service 305 may be an active service that is capable of responding to procedures from the network and initiating procedures in the network on the behalf of the UE 115-b. As an active service the UE delegation service 305 may maintain an updated mirror of the status and configuration of the UE 115-b. Therefore, the UE delegation service 305 may be capable of actively acting on the behalf of the UE 115-b in an accurate and efficient manner. For example, the UE delegation service 305 may obtain the service management message 340 from a first device (e.g., the UE 115-b) for updating the UE delegations service 305 with the status of the first device and one or more dynamic preferences of the first device. Further, the UE delegation service 305 may output the service management message 340 to the first device for updating or affecting a status of the first device and the one or more dynamic preferences of the first device based on the UE delegation service 305 communicating with one or more service modules. In some other examples, the UE delegation service 305 may be a passive service (e.g., inactive in procedures) that can respond to procedures in the network on the behalf of the UE 115-b but refrains from initiating procedures. The passive UE delegation service 305 may also maintain a set of preferences for the UE 115-b, however, the set or preferences may be static and are indicated to the UE delegation service 305 when initially connected with the UE 115-b.

In the case of the active UE delegation service 305, as described herein in accordance with one or more aspects of the present disclosure, the UE delegation service 305 and the UE 115-b may communicate via an interface or communication link. Additionally, or alternatively, the interface between the UE 115-b and the UE delegation service 305 may be different for different types of UEs 115. For example, the vendor of the UE 115-b (e.g., the manufacturer of the UE 115-b or company that deploys the UE 115-b) may develop and manage the UE delegation service 305. In some examples, the interface may the same for a group of UEs 115. For example, a network vendor, a UE 115 vendor, or a third-party vendor may develop and manage the UE delegation service 305. Further, the UE delegation service 305 may be configured for a single UE 115 (e.g., the UE 115-b) or for a group of UEs 115 in a wireless network (e.g., the wireless communications system 300).

The UE delegation service 305 may also include a control plane and a user plane to communicate and remain up to date with the UE 115-b. The UE delegation service 305 may use the control plane to maintain up to date information about the control plane services of the UE 115-b. Similarly, the UE delegation service 305 may use the user plane to maintain up to date information about the user plane traffic of the UE 115-b. Additionally, or alternatively, the network may manage such aspects of the control plane and user plane of the UE delegation service 305. In some other examples, the network may use the control plane and user plane of the UE delegation service 305 to determine a state or configuration for the UE 115-b or to save long term service agreements that are established between the network and the UE 115-b (e.g., a user consent agreement).

Further, the UE delegation service 305 may refrain from recreating the physical environment of the UE 115-b as is done by digital twins of UEs 115. For example, the physical environment of the UE 115-b may change relatively rapidly and thus recreating the physical environment of the UE 115-b may consume a relatively large quantity of computational resources. Thus, instead of recreating the physical environment of the UE 115-b, the UE delegation service may receive updates from the UE 115-b regarding the environment of the UE 115-b. Based on such information on the UE 115-b, the user plane of the UE delegation service 305 may act on behalf of the UE 115-b to perform one or more actions. For example, the UE delegation service 305 may use the user plane to negotiate runtime scheduling requirements (e.g., traffic periodicities), maintain statistics on the performance of the user plane (e.g., the fulfillment of quality of service (QOS) for the UE 115-b), to update the traffic routing in the network after mobility events (e.g., RAT changes), or any combination thereof.

In some examples, the user plane of the UE delegation service 305 may also aggregate keep alive messages from network services (e.g., services 310). Keep alive messages may be messages sent between two wireless devices on a wireless link to determine the functionality of the wireless link and to prevent the disconnection of the wireless link. Thus, the UE delegation service 305 may aggregate keep alive messages sent from the UE 115-b or keep alive messages answered in the network based on a keep alive message from a separate UE delegation service 305. Additionally, or alternatively, if security keys are shared, the UE delegation service 305 may terminate the transmission control protocol (TCP) on the network and split the data traffic over multiple bearers, sub-services, RATS, or any combination thereof.

Moreover, the UE delegation service 305 may act as a negotiator for one or more configurations or capabilities of the UE 115-b. In some examples, to accurately negotiate on behalf of the UE 115-b, the UE delegation service 305 may hold (e.g., store) up to date information about the state and preferences of the UE 115-b within the wireless communications system 300. As such, the UE delegation service 305 use the status and preferences of the UE 115-b to negotiate one or more configurations (e.g., QoS configurations, carrier configurations including a quantity of carriers, energy saving configurations, overheating configurations, or any combination thereof) for the UE 115-b. The UE delegation service 305 may also negotiate capability request changes and mobility preparations for the UE 115-b on the behalf of the UE 115-b.

In some examples, the network services 310 may also use the UE delegation service 305 for service configuration negotiations. For example, as a part of the service configuration negotiations, the UE delegation service may output or obtain a service configuration request message 345 that requests an establishment of a service associated with a first device (e.g., the UE 115-b). Thus, the UE delegation service 305 may communicate, with the network services 310 and with at least one service module of a set of one or more service modules, one or more service configuration messages 350 to negotiate the service configuration of the service for the first device with the at least one service module. Additionally, or alternatively, the negotiations may be based on the service configuration request message 345, the service management message 340, or both. In some examples, the network services 310 may rely of the UE delegation service 305 as a reference for the states and preferences of the UE 115-b to provide stateless services to the UE 115-b. That is, the network may keep the states of the UE 115-b based on a network perceived configuration and the UE 115-b may autonomously update information to be used in subsequent negotiations. In some examples, the UE 115-b may be a first recipient of a service configuration. For example, the services 310 may provide a list of prioritized services per functionality and negotiate with the UE delegation service 305 to determine the most efficient configuration for the UE 115-b. The UE 115-b may then receive the service configuration from the network (e.g., the network entity 105-a, the one or more services 310, or any combination thereof) and confirm the service configuration with the network. For example, if the service configuration is received and decoded successfully, the UE 115-b may transmit a HARQ-ACK message, or if the service configuration is unsuccessfully received, decoded, or both, the UE 115-b may transmit a HARQ-NACK message. Additionally, or alternatively the UE 115-b may transmit the HARQ-NACK message after a timer indicating a duration to wait for a service configuration has expired.

After the UE 115-b is configured with the service configuration the UE delegation service 305 may be updated with the service configuration that the UE 115-b is configured with to maintain a mirror of the UE 115-b. In some examples, the UE delegation service 305 may perform the update after the UE 115-b transmits the confirmation message to the network (e.g., to the network entity 105-a) indicating that the configuration was successful. Further, the network may consider the service configuration successful after the network (e.g., the network entity 105-a) receives the confirmation message from the UE 115-b.

In some examples, the UE delegation service 305 may determine the service configuration for the UE 115-b. For example, the UE delegation service 305 may initiate a configuration or reconfiguration procedure and relay the configuration or reconfiguration request to the UE 115-b. The UE delegation service 305 may then reconfirm the configuration with the network after receiving a confirmation message from the UE 115-b. As such, the configuration procedure may be complete after both the UE delegation service 305 and the UE 115-b have confirmed the configuration. Additionally, or alternatively, the UE delegation service 305 may be capable of monitoring the performance of the UE 115-b and interfacing with data collection services (e.g., a data collection service 310 within the service-based network 315). Such performance metrics may be accessed by network or service operators of UE 115 vendors to determine if a reconfiguration should be initiated. Further, based on such performance information, the UE delegation service 305 may test different or alternative interface engines for the UE 115-b and provide a comparative analysis of the tests to the UE 115-b, the network or service operator, the UE 115 vendor of the UE 115-b, or any combination thereof.

Therefore, the UE delegation service 305 may help reduce the energy and data consumption of the UE 115-b while maintaining a constant presence from the network perspective. For example, the UE delegation service 305 may minimize the quantity of round-trip negotiations that are performed over-the-air, which may be relatively large as the quantity of services 310 that are configured with the UE 115-b increases in 6G communications. Additionally, or alternatively, the UE delegation service 305 may also provide the network a consistent entity or service that can be queried allowing the network the capability to refrain from keeping track of the discontinuous reception (DRX) or discontinuous transmission (DTX) mode. Thus, the UE 115-b may experience a decrease in power consumption.

Further, the UE delegation service 305 may allow for an increase in security within the wireless communications system 300 by anonymizing the UE 115-b. For example, the UE delegation service 305 may decouple the UE 115 identifier (ID) from the temporary network IDs. Thus, the UE delegation service 305 may be capable of providing user specific predictions on mobility, traffic predictions, user habits, or any combination thereof in an anonymous manner. Such techniques may be useful when the UE 115-b is connecting to a public network. The UE delegation service 305 may also be capable of answering keep alive messages for one or more services 310 or for the UE 115-b resulting in additional energy and power savings as the services 310 or UE 115-b can remain in a ‘sleep’ or idle state for relatively longer periods of time.

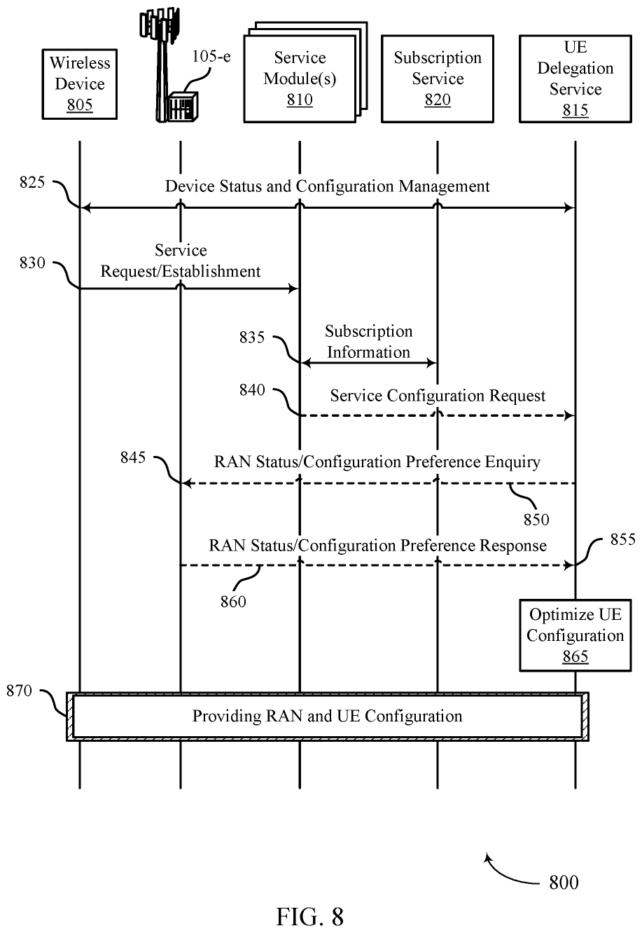

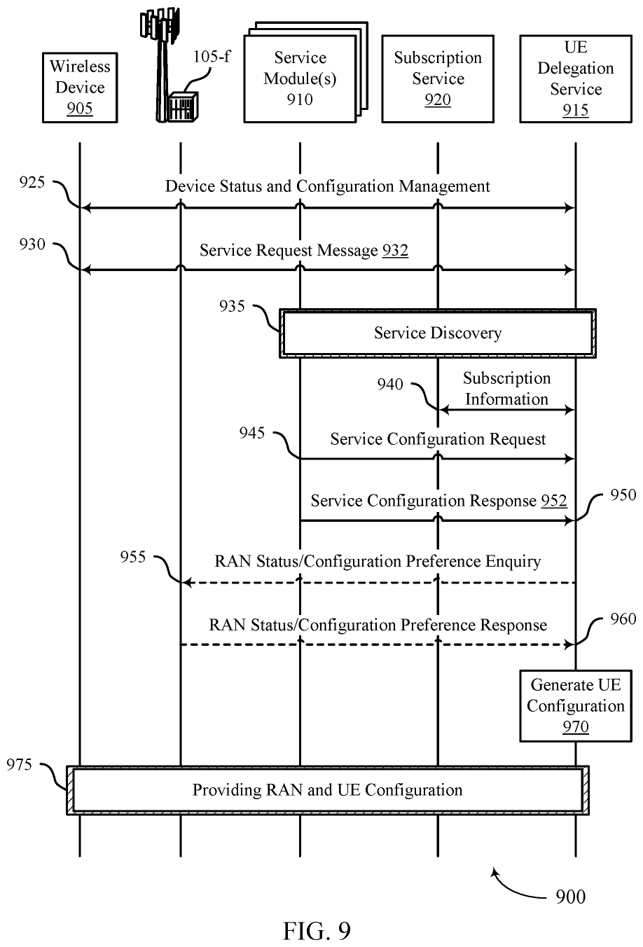

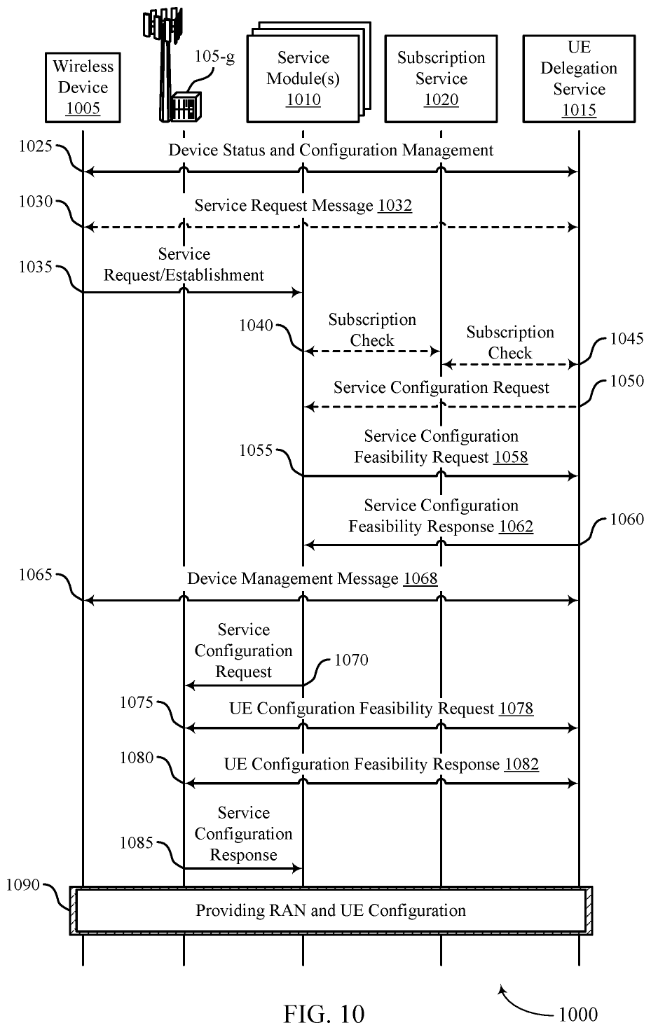

Additionally, or alternatively, the UE delegation service 305 may increase the complexity of the wireless communications system 300. However, such increase in complexity may be outweighed by the decrease in latency, power consumption, energy consumption, messaging overhead, or any combination thereof. Therefore, the wireless communications system 300 may be more efficient and reliable while using the UE delegation service 305. For example, the UE delegation service 305 may allow the network to relatively quickly query for the preferences, capabilities, and the status of a UE 115 (e.g., the UE 115-b). Further, in some examples, in accordance with one or more aspects of the present disclosure as described with reference to FIGS. 8 and 9, the UE delegation service 305 may allow for the network to relatively quickly and more efficiently negotiate and request network and other service configurations for the UE 115-b. In some other examples, in accordance with one or more aspects of the present disclosure as described with reference to FIG. 10, the UE delegation service 305 may be capable of relatively quickly providing a set of preferred UE 115 configurations for the UE 115-b.

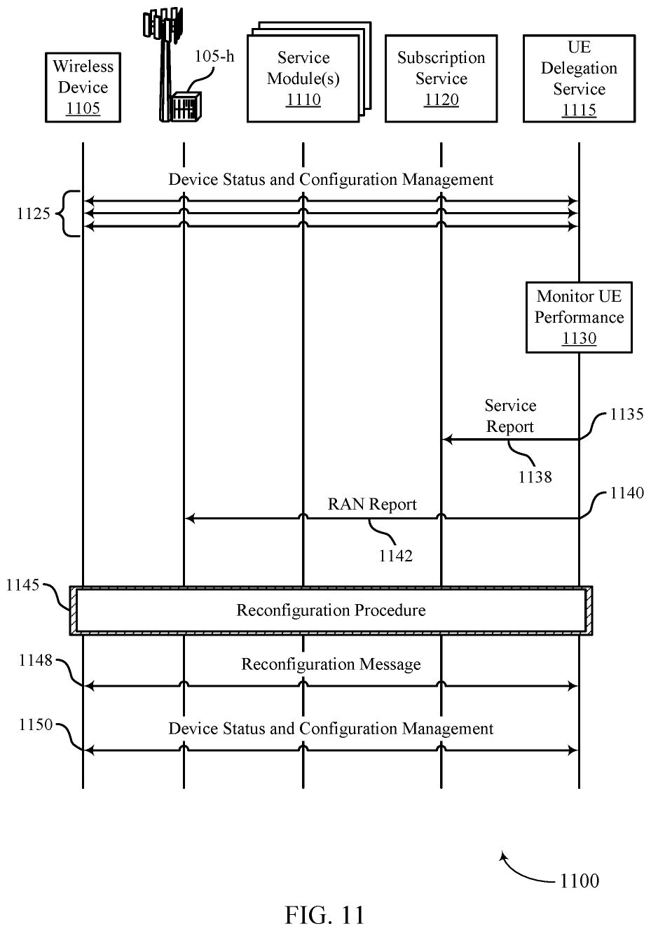

In another example, in accordance with one or more aspects of the present disclosure as described with reference to FIG. 11, the UE delegation service 305 may be capable of monitoring the performance of the UE 115-b and interfacing with data collection services 310 that can be accessed by a network/service operator or a UE 115 vendor. The UE delegation service 305 may also test different UE 115 interface engines and provide a comparative analysis to the UE 115-b, a network/service operator, a UE vendor, or any combination thereof. Further, the UE delegation service 305 may provide or suggest one or more configurations for the UE 115-b to the network based on the current performance of the UE 115-b. Additionally, or alternatively, as described herein, the UE delegation service 305 may allow for the UE 115-b to be anonymous within the network. For example, the UE delegation service 305 may call one or more APIs and insert data in a secure manner that refrains from including or using any personally identifiable information (PII). The UE delegation service 305 may also collect one or more statistics about the UE 115-b, provide optimizations for the UE 115-b, or both.

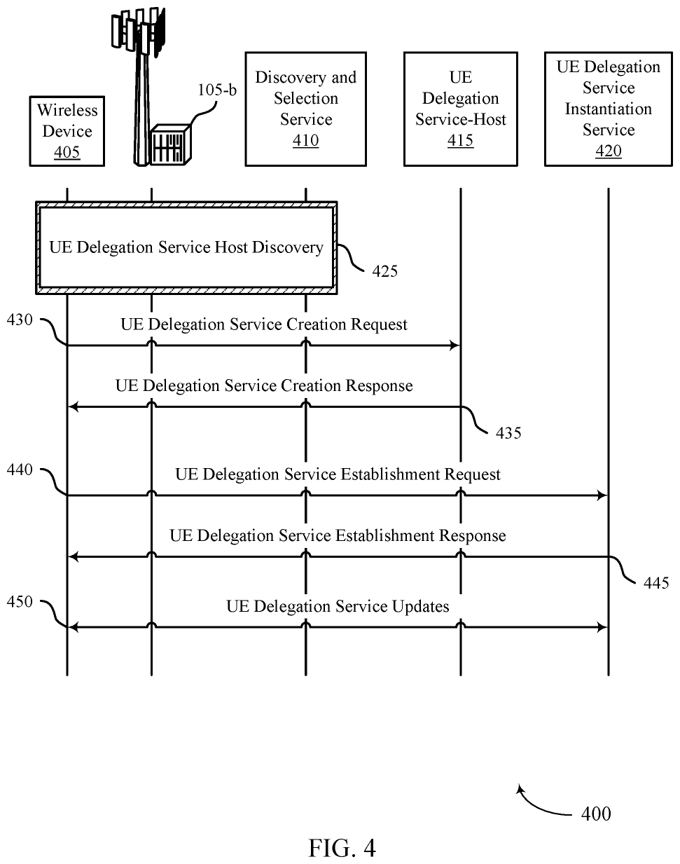

Additionally, or alternatively, the creation and establishment of the UE delegation service 305 may be described elsewhere herein in accordance with one or more aspects of the present disclosure with reference to FIGS. 4 through 6. For example, herein in accordance with one or more aspects of the present disclosure, FIGS. 4 through 6 may describe the creation of the UE delegation service 305 in a UE delegation service 305 host service. FIGS. 4 through 6 may also describe the UE delegation service 305 being hosted within the network and procedures for a UE 115 (e.g., the UE 115-b) to generate or create a UE delegation service 305 at a hosting service (e.g., a service 310). Additionally, or alternatively, it should be understood that in accordance with the one or more aspects of the present disclosure, the UE delegation service 305 may be hosted as a separate service 310, within one or more service 310, as an aggregate service 310 (e.g., made up of one or more services 310), or any combination thereof.

FIG. 4 shows an example of a process flow 400 that supports a UE delegation service in accordance with one or more aspects of the present disclosure. In some examples, the process flow 400 may implement or be implemented by the wireless communications system 100, the network architecture 200, and/or the wireless communications system 300. For example, the process flow 400 may include a wireless device 405 (e.g., a UE 115), a network entity 105-b, a discovery and selection service 410, a UE delegation service host 415, and a UE delegation service instantiation service 420, which may be examples of devices or services described herein with reference to FIGS. 1 through 3.

In the following description of the process flow 400, the operations between the wireless device 405, the network entity 105-b, the discovery and selection service 410, the UE delegation service host 415, and the UE delegation service instantiation service 420 may be performed in different orders or at different times. Some operations may also be left out of the process flow 400, or other operations may be added. Although the wireless device 405, the network entity 105-b, the discovery and selection service 410, the UE delegation service host 415, and the UE delegation service instantiation service 420 are shown performing the operations of the process flow 400, some aspects of some operations may also be performed by one or more other wireless devices.

In some examples, the wireless device 405 may be an example of a UE 115 or a group of UEs 115 as described elsewhere herein. Additionally, or alternatively, the network entity 105-b may be an example of a single network entity 105 or a group of network entities 105. Further, the discovery and selection service 410 may be a service within the network of the network entity 105-b. Additionally, or alternatively, the wireless device 405 and the network entity 105-b may use the discovery and selection service 410 to discover other services within the network and select services to be configured with the wireless device 405. A service may be described elsewhere herein with reference to FIG. 3. Moreover, the discovery and selection service 410 may assist in discovering a UE delegation service host 415 for UE delegation service. The UE delegation service may be an example of a service on the network that is capable of acting on behalf of the wireless device 405 for service negotiation procedures, thus decreasing the quantity of over-the-air messaging.

Thus, at 425, the wireless device 405 and the network entity 105-b may discover the UE delegation service host 415. Additionally or alternatively, the wireless device 405 and the network entity 105-b may use the discovery and selection service 410 to aid in the discovery of the UE delegation service host 415. Further, the wireless device 405 may receive an indication of the UE delegation service host 415 (e.g., via an advertisement of the UE delegation service host 415) such that the wireless device 405 can register with the UE delegation service host 415. As part of the registration, at 430, the wireless device 405 may transmit, to the UE delegation service host 415, a UE delegation service creation request. Thus, at 435, the wireless device 405 may receive, from the UE delegation service host 415, a UE delegation service creation response. The UE delegation service creation request and response signaling may indicate for the UE delegation service instantiation service 420 to generate a UE delegation service within the network. Thus, in some examples, the UE delegation service host 415 and the UE delegation service instantiation service 420 may communicate via a communication link. Additionally, or alternatively, the UE delegation service creation request message may include an identifier (ID) for the wireless device 405 (e.g., a UE 115 ID) and a UE delegation service image to be used. For example, the wireless device 405 may reference an external source (e.g., a database or data store within the wireless communications system) where a container for a UE delegations service can be downloaded. A server of the vendor for the wireless device 405 (e.g., a UE 115 vendor server) may provide such image as a secure uniform resource locator (URL) link from a UE vendor server.

Following the creation and generation of the UE delegation service, at 440, the wireless device 405 may transmit, to the UE delegation service instantiation service 420, a UE delegation service establishment request message to register the wireless device 405 with the UE delegation service. Additionally or alternatively, the UE delegation service establishment request message may include information about the wireless device 405 such as an identifier (ID) for the wireless device 405. For example, if the wireless device 405 is a UE 115, the UE delegation service establishment request message may include a UE 115 ID. At 445, the wireless device 405 may then receive, from the UE delegation service instantiation service 420, a UE delegation service establishment response message that indicates the one or more services provided by the UE delegation service hosted at the UE delegation service host 415.

Additionally, or alternatively, the one of the services may be that the UE delegation service is capable of acting as a preferences proxy for the wireless device 405. For example, instead of the network entity 105-b transmitting one or more over-the-air messages to the wireless device 405 to determine the preferences of the wireless device 405, the network entity 105-b may query the UE delegation service that is on the network to receive the preferences of the wireless device 405. In some examples, UE delegation service establishment response message may indicate that the UE delegation service may act as a configuration proxy for the wireless device 405. As a configuration proxy, the UE delegation service may provide the network (e.g., the network entity 105-b) the functionality and capability of querying the UE delegation service for the configuration preferences of the wireless device 405. Further, the network entity 105-b may receive and view a configuration menu for the wireless device 405 that indicates one or more pre-established configurations between the network and the wireless device 405.

Additionally, or alternatively, the configurations between the network (e.g., the network entity 105-b and the services of the network) and the wireless device 405 may be considered stateless or stateful network configurations. A stateless network configuration may be where the network (e.g., the network entity 105-b) relies on the UE delegation service to provide the state of the wireless device 405. Thus, the network entity 105-b may query the UE delegation service for the latest state of the wireless device 405. A stateful configuration may be when the network (e.g., the network entity 105-b sends a service configuration to the wireless device 405 and waits for some confirmation (e.g., an ACK message) to confirm the state of the wireless device 405. Thus, the network may keep track of the current state of the wireless device 405 and may use the UE delegation service as a registry that the network can query to obtain the current preferences of the wireless device 405. Further, the UE delegation service establishment response message may also indicate a configuration for the wireless device 405. Such configurations may indicate whether the wireless device 405 or the UE delegation service receive a service configuration or reconfiguration first. Additionally, or alternatively, using such configurations for the network and the wireless device 405, the UE delegation service establishment response message may also indicate that the UE delegation service is capable of being used for user plane enhancements, such as routing traffic (e.g., uplink data traffic, downlink data traffic, or both), traffic shaping, traffic optimization, or any combination thereof.

At 450, the wireless device 405 and the UE delegation service instantiation service 420 may also share one or more service updates for the service between the wireless device 405 and the UE delegation service. For example, the wireless device 405 may update the UE delegation service with information specific to the wireless device 405. In some examples, the wireless device 405 may transmit the service updates based on the wireless device 405 moving out of a service area (e.g., a cell or coverage area of a network entity 105). In some other examples, the wireless device 405 may transmit the service updates based on the wireless device 405 being unable to support one or more services due to one or more constraints (e.g., power status of the wireless device 405, computation resource status of the wireless device 405). Additionally, or alternatively, the wireless device 405 may transmit the service updates based on a change or update to the preferences of the wireless device 405, the one or more services, or both.

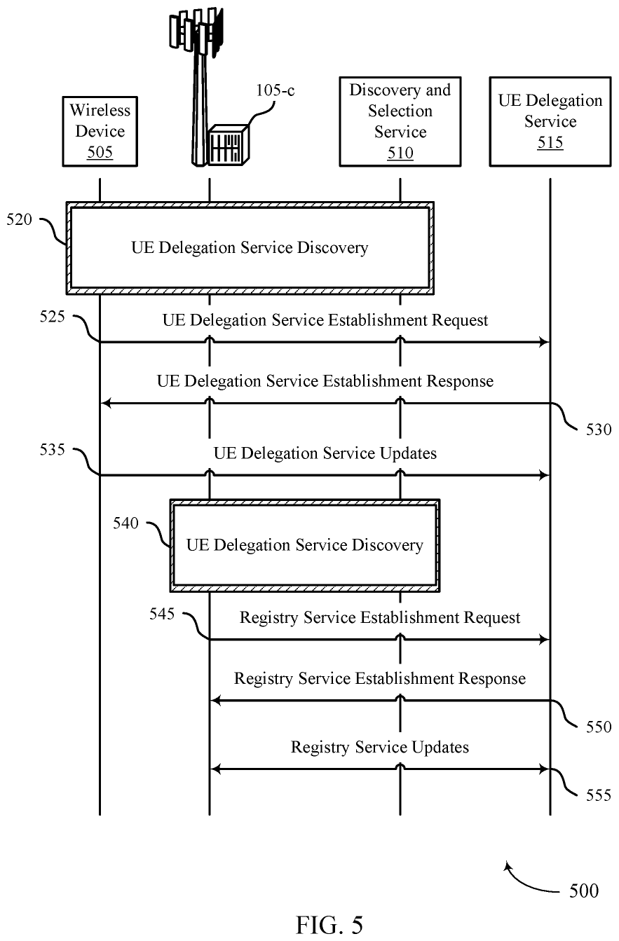

FIG. 5 shows an example of a process flow 500 that supports a UE delegation service in accordance with one or more aspects of the present disclosure. In some examples, the process flow 500 may implement or be implemented by the wireless communications system 100, the network architecture 200, and/or the wireless communications system 300. For example, the process flow 500 may include a wireless device 505 (e.g., a UE 115), a network entity 105-c, a discovery and selection service 510, and a UE delegation service 515, which may be examples of devices or services described herein with reference to FIGS. 1 through 3.

In the following description of the process flow 500, the operations between the wireless device 505, the network entity 105-c, the discovery and selection service 510, and the UE delegation service 515 may be performed in different orders or at different times. Some operations may also be left out of the process flow 500, or other operations may be added. Although the wireless device 505, the network entity 105-c, the discovery and selection service 510, and the UE delegation service 515 are shown performing the operations of the process flow 500, some aspects of some operations may also be performed by one or more other wireless devices.

At 520, in accordance with the one or more aspects of the present disclosure described with reference to FIG. 4, the wireless device 505 and the network entity 105-c may use the discovery and selection service 510 to discover the UE delegation service 515. Additionally, or alternatively, instead of the UE delegation service 515 being created for a wireless device (e.g., the wireless device 505, a UE 115), the UE delegation service 515 may be shared between multiple wireless devices (e.g., a group of UEs 115) within a wireless communications system. Thus, once the UE delegation service 515 is discovered at 520, at 525, the wireless device 505 may transmit, to the UE delegation service 515, a UE delegation service 515 establishment request message (e.g., a service management message). In response, at 530, the UE delegation service 515 may transmit, to the wireless device 505, a UE delegation service 515 establishment response message. After the establishment between the wireless device 505 and the UE delegation service 515 is complete, at 535. the wireless device 505 may transmit, to the UE delegation service 515, one or more service updates. In some examples, the service updates may include one or more updates or changes to the preferences of the wireless device 505. In such examples, the UE delegation service 515 may be shared through regular network configurations. Additionally, or alternatively, the wireless device 505, the network entity 105-c, and services of the network may use similar procedures to discover the location of the UE delegation service 515 (e.g., where the UE delegation service 515 is hosted). For example, the UE delegation service 515 may be hosted within a service of the network, a collection of services, within a cloud platform of the network, or any combination thereof.

Further, at 540, in accordance with the one or more aspects of the present disclosure described with reference to FIG. 4, the network entity 105-c and the discovery and selection service 510 may communicate or interface with each other to discover the UE delegation service 515. For example, at 545, the network entity 105-c may transmit, to the UE delegation service 515, a registry service establishment request to register the network entity 105-c with the UE delegation service 515. In some examples, the network entity 105-c may transmit the registry service establishment request such that the network entity 105-c can query the UE delegation service 515 for the preferences of the wireless device 505 stored at the UE delegation service 515. In response, at 550, the UE delegation service 515 may transmit, to the network entity 105-c, a registry service establishment response message, that confirms the establishment of the registry service at the UE delegation service 515 and the connection between the network entity 105-c and the UE delegation service 515. Further, at 555, the network entity 105-c and the UE delegation service 515 may share one or more service updates. For example, the UE delegation service 515 may update the network entity 105-c with updates to the preferences of the wireless device 505 and the network entity 105-c may update the UE delegation service 515 with the preferences of the network entity 105-c.

In addition, in some examples, the UE delegation service 515 may be a separate network service per wireless device (e.g., the wireless device 505) or the UE delegation service 515 may be a separate network service per wireless device vendor. That is, the UE delegation service 515 may be configured separately for each individual wireless device (e.g., UE 115) or per each wireless device associated with the same vendor (e.g., UE 115 vendor). In some other examples, the UE delegation service 515 may be a separate network service per a group of wireless devices as the interface between a respective wireless device (e.g., the wireless device 505) and the UE delegation service 515 may be standardized and the same for each wireless device.

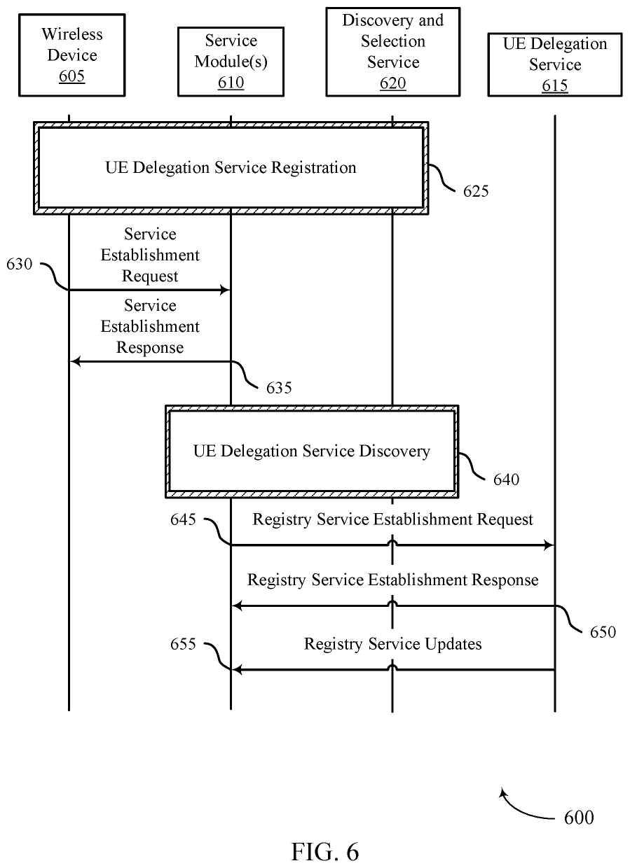

FIG. 6 shows an example of a process flow 600 that supports a UE delegation service in accordance with one or more aspects of the present disclosure. In some examples, the process flow 600 may implement or be implemented by the wireless communications system 100, the network architecture 200, and/or the wireless communications system 300. For example, the process flow 600 may include a wireless device 605 (e.g., a UE 115), one or more service modules 610, a UE delegation service 615, and a discovery and selection service 620, which may be examples of devices or services described herein with reference to FIGS. 1 through 3.

In the following description of the process flow 600, the operations between the wireless device 605, the one or more service modules 610, the UE delegation service 615, and the discovery and selection service 620 may be performed in different orders or at different times. Some operations may also be left out of the process flow 600, or other operations may be added. Although the wireless device 605, the one or more service modules 610, the UE delegation service 615, and the discovery and selection service 620 are shown performing the operations of the process flow 600, some aspects of some operations may also be performed by one or more other wireless devices.

At 625, the network (e.g., a network entity 105. the one or more service modules 610, the discovery and selection service 620, or any other combination thereof) may discover the UE delegation service 615 during the establishment of the service or connection between the wireless device 605 and a network entity 105 or the one or more service modules 610. For example, at 630, the wireless device 605 may transmit, to the one or more service modules 610, a service establishment request message to establish a service or connection between the wireless device 605 and the one or more service modules 610. At 635, the one or more service modules 610 may then transmit, to the wireless device 605, a service establishment response message confirming the establishment of the service or connection. Additionally, or alternatively, the service establishment response message may be an example of a HARQ-ACK message or any other type of message described herein that can acknowledge or indicate the successful connection between the wireless device 605 and the one or more service modules 610.

Further, at 640, the one or more service modules 610 may discover the UE delegation service through use of the discovery and selection service 620. Therefore, once the one or more service modules 610 know of the existence of the UE delegation service 615, the one or more service modules 610 may subscribe to the UE delegation service 615. For example, at 645, the one or more service modules 610 may transmit, to the UE delegation service 615, a registry service establishment request message. Further, at 650, the one or more service modules 610 may receive, from the UE delegation service 615, a registry service establishment response message that confirms or acknowledges a successful connection between the one or more service modules 610 and the UE delegation service 615. Such messages at 645 and 650 may be examples of the one or more service modules 610 subscribing to the UE delegation service 615.

Thus, at 655, the one or more service modules 610 may receive, from the UE delegation service 615, one or more service updates based on the subscriptions. In some examples, the one or more service updates may indicate reports from the wireless device 605 (e.g., UE 115 reports), activities of the wireless device 605, measurements from the wireless device 605, state changes of the wireless device 605, or any combination thereof. The one or more service modules 610 may then use such information from the service updates to configure or reconfigure the connection between the wireless device 605 and the one or more service modules 610.

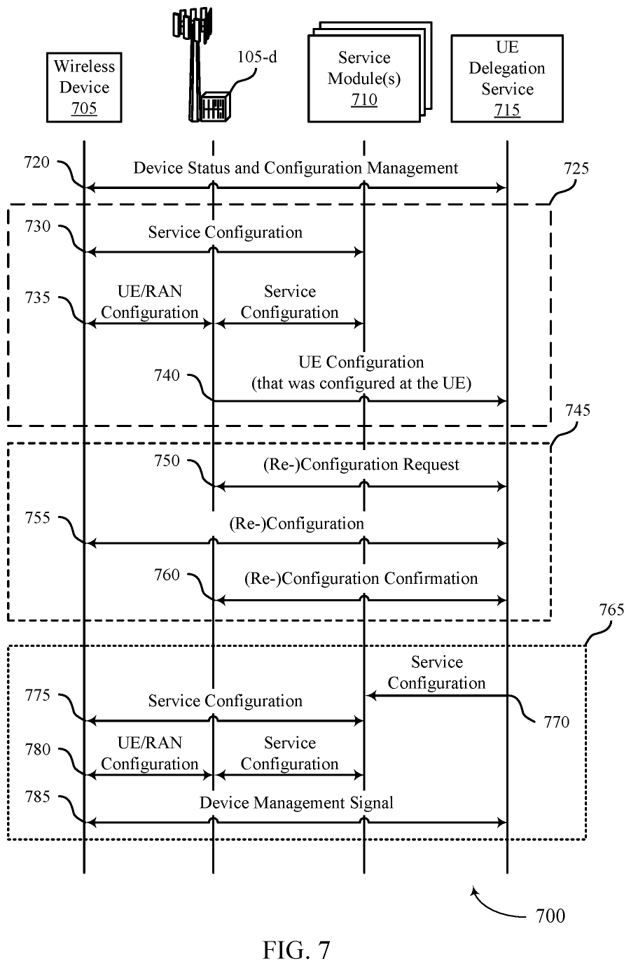

FIG. 7 shows an example of a process flow 700 that supports a UE delegation service in accordance with one or more aspects of the present disclosure. In some examples, the process flow 700 may implement or be implemented by the wireless communications system 100, the network architecture 200, and/or the wireless communications system 300. For example, the process flow 700 may include a wireless device 705 (e.g., a UE 115), a network entity 105-d, one or more service modules 710, and a UE delegation service 715, which may be examples of devices or services described herein with reference to FIGS. 1 through 3.

In the following description of the process flow 700, the operations between the wireless device 705, the network entity 105-d, the one or more service modules 710, and the UE delegation service 715 may be performed in different orders or at different times. Some operations may also be left out of the process flow 700, or other operations may be added. Although the wireless device 705, the network entity 105-d, the one or more service modules 710, and the UE delegation service 715 are shown performing the operations of the process flow 700, some aspects of some operations may also be performed by one or more other wireless devices.

At 720, the wireless device 705 and the UE delegation service 715 may communicate via an interface that can be standardized or non-standardized. That is, the interface be standardized for each wireless device within a wireless communication system or be for different (e.g., non-standardized) for each wireless device. In some examples, the wireless device 705 and the UE delegation service 715 may share a device status and configuration management message via the interface.

At 725, the network (e.g., the network entity 105-d) may configure the wireless device 705 with a service prior to the UE delegation service 715. For example, at 730, the wireless device 705 and the one or more service modules 710 establish a service configuration. In some examples, the service configuration at 730 may include one or more service configurations for each of the one or more service modules 710. That is, the wireless device 705 may be configured with a service configuration for each of the one or more service modules 710. Further, at 735, the wireless device 705 and the network entity 105-d may establish a service configuration between the wireless device 705 (e.g., a UE 115) and the network entity 105-d. In addition, the network entity 105-d may share the service configuration between the wireless device 705 and the network entity 105-d with the one or more service modules 710.

Once such service configurations are established and confirmed, at 740, the network entity 105-d may transmit, to the UE delegation service 715, the configuration of the wireless device 705. Thus, at 725, the wireless device 705 and the UE delegation service 715 may be synchronized separately with the service configuration for the wireless device 705. For example, the UE delegation service 715 may communicate one or more messages to negotiate one or more parameters of a service configuration for the wireless device 705. The UE delegation service 715 may then obtain, from the network entity 105-d (e.g., a second device in a wireless network that is a network entity 105 of a RAN) the service configuration based on the one or more messages.

At 745, the network may configure the UE delegation service 715 first. For example, at 750, the UE delegation service 715 may receive, from the network entity 105-d, a configuration or reconfiguration request. In another example, the UE delegation service 715 may transmit the request message to the network entity 105-d at 750. For example, the UE delegation service 715 may monitor the performance of the wireless device 705 and determine that the service configuration of the wireless device 705 should be reconfigured based on the performance of the wireless device 705. Additionally, or alternatively, the UE delegation service 715 may use a machine learning (ML) or artificial intelligence (AI) model (e.g., an AI/ML model) to make such determinations.

Thus, in response to the configuration/reconfiguration request, the network entity 105-d and the UE delegation service 715 may negotiate the parameters of a configuration for the wireless device 705. Thus, the UE delegation service 715 may be configured with the configuration or reconfiguration for the wireless device 705. Then to configure the wireless device 705 with the configuration, at 755, the UE delegation service 715 may transmit the configuration or reconfiguration to the wireless device 705. Following, at 760, the UE delegation service 715 may transmit a configuration/reconfiguration confirmation to the network entity 105-d to indicate that the wireless device 705 has received the negotiated configuration. Thus, the UE delegation service 715 may act as a relay to relay the service negotiation to the wireless device 705 for the network.

At 765, the UE delegation service 715 may determine one or more parameters of the service configuration for the wireless device 705. In addition, the UE delegation service 715 may communicate, with the one or more service modules 710, one or more messages that include the one or more parameters of the service configuration for the wireless device 705. In such case, the UE delegation service 715 may be configured to determine a configuration for the wireless device 705 and transmit the configuration to the network entity 105-d and the one or more service modules 710. For example, at 770, the UE delegation service 715 may transmit the service configuration for the wireless device 705 to the one or more service modules 710. At 775, the one or more service modules 710 may transmit and configure the wireless device 705 with the service configuration received at 770. Further, at 780, the one or more service modules 710 may share the service configuration with the network entity 105-d such that the network entity 105-d can transmit and configure the wireless device 705 with a UE 115/RAN configuration. Following, at 785, the wireless device 705 may transmit a device management signal to the UE delegation service 715 to update the UE delegation service 715 with the current status of the wireless device 705. The wireless device 705 may also transmit device management signal to indicate a change in preferences or a mobility indication (e.g., to indicate the UE delegation service 715 of an upcoming mobility event).

Further descriptions of the UE delegation service 715 negotiating on the behalf of the wireless device 705 to reduce the signaling overhead between the network ant the wireless device 705 thus improving the performance of the wireless communications system may be described elsewhere herein with reference to FIGS. 8 through 11. For example, FIGS. 8 and 9 may describe the UE delegation service 715 being used to assist in configuring the wireless device 705. FIG. 10 may describe the UE delegation service 715 being used as a registry to assist the network entity 105-d and the one or more service modules 710 in determining a configuration for the wireless device 705. In addition, FIG. 11 may describe the UE delegation service 715 monitoring and reporting the performance of the wireless device 705 to the network entity 105-d and the one or more service modules 710 for determining a reconfiguration for the wireless device 705.

FIG. 8 shows an example of a process flow 800 that supports a UE delegation service in accordance with one or more aspects of the present disclosure. In some examples, the process flow 800 may implement or be implemented by the wireless communications system 100, the network architecture 200, and/or the wireless communications system 300. For example, the process flow 800 may include a wireless device 805 (e.g., a UE 115), a network entity 105-e, one or more service modules 810, a UE delegation service 815, and a subscription service 820, which may be examples of devices or services described herein with reference to FIGS. 1 through 3.

In the following description of the process flow 800, the operations between the wireless device 805, the network entity 105-e, the one or more service modules 810, the UE delegation service 815, and the subscription service 820, may be performed in different orders or at different times. Some operations may also be left out of the process flow 800, or other operations may be added. Although the wireless device 805, the network entity 105-e, the one or more service modules 810, the UE delegation service 815, and the subscription service 820 are shown performing the operations of the process flow 800, some aspects of some operations may also be performed by one or more other wireless devices.

At 825, the wireless device 805 and the UE delegation service 815 may communicate the device status and configuration management information via an interface. In some examples, the UE delegation service 815 may use the interface between the wireless device 805 and the UE delegation service 815 to obtain the status of the wireless device 805 or to synchronize with the wireless device 805. In some other examples, the UE delegation service 815 may use the respective interface to configure the wireless device 805 for different services while refraining from exposing proprietary information about the wireless device 805. Additionally, or alternatively, the wireless device 805 and the UE delegation service 815 may use the interface to share device management information. For example, the wireless device 805 may report statistics of the performance of the wireless device 805 to the UE delegation service 815. Further the device management information may be used to download an AI/ML model at the UE delegation service 815 that can assist the UE delegation service 815 in negotiating on the behalf of the wireless device 805.

At 830, the wireless device 805 may transmit, to the one or more service modules 810, a service request or establishment message. In response, at 835 the one or more service modules 810 may transmit, to the subscription service 820, subscription information. Additionally, or alternatively, the subscription information may indicate which services the wireless device 805 requested to establish a service with. Further, the subscription information may also include one or more other parameters for the service establishment indicated by the wireless device 805.

At 840, the UE delegation service 815 may obtain, from at least one service module 810 of the one or more service modules 810, a service configuration request message (e.g., the service configuration request message 345 as described with reference to FIG. 3). The service configuration request may indicate that the wireless device 805 requested to be configured with a service configuration for one or more services corresponding to the one or more service modules 810. In some examples, the one or more service modules 810 may transmit the service configuration request to the UE delegation service 815 based on receiving the service request/establishment message from the wireless device 805.

Additionally, or alternatively, at 845, the UE delegation service 815 may output (e.g., transmit), to the network entity 105-e (e.g., a second device in the wireless network), a service configuration preference request message 850. That is, the UE delegation service 815 may transmit a RAN status and configuration preference enquiry to the network entity 105-e to obtain the status and preferences of the network entity 105-c. Thus, at 855, the UE delegation service 815 may obtain, from the network entity 105-e (e.g., the second device), an indication of one or more configuration preferences 860 for the service configuration based on the service configuration preference request message 850 outputted at 845. Therefore, the UE delegation service 815 may receive a RAN status and configuration preference response to indicate the status and configuration preferences of the network entity 105-e to the UE delegation service 815.

At 865, the UE delegation service 815 may determine the configuration for the wireless device 805 based on the service configuration request received at 840, on the RAN status and configuration preference response received at 855 (e.g., the indication of one or more configuration preferences 860), or both. That is, the UE delegation service 815 may negotiate with the one or more service modules 810 and the network entity 105-e on behalf of the wireless device 805 to determine a configuration for the wireless device 805. In an example, the UE delegation service 815 may determine the configuration for the wireless device 805 based on the service configuration request, one or more RAN allocated resources, and a RAN configuration preference. Further, at 865, the UE delegation service 815 may communicate one or more messages to negotiate one or more parameters of the service configuration of the wireless device 805 on the behalf of the wireless device 805. In some examples, the parameters of the service configuration may be based on a service management message 340 described with reference to FIG. 3, the service configuration request message 345 described with reference to FIG. 3 and received at 840, the one or more configuration preferences of the network entity 105-e, or any combination thereof. In some examples, at 870, the network entity 105-e or the one or more service modules 810 may transmit the configurations for the wireless device 805, the network entity 105-e, or both. Further, the UE delegation service 815 may provide a device management signal to the wireless device 805 via the interface between the wireless device 805 and the UE delegation service 815. Such device management signal may be used by the wireless device 805 for one or more AI/ML models. In some examples, the network entity 105-e may allocate resources to the wireless device 805, without the UE delegation service 815, by taking one or more preferences of the network entity 105-e into consideration (e.g., the network entity 105-e decides in one shot). In some examples, the UE delegation service 815 may refrain from coordinating with the network entity 105-e at 845 and 850 and the one or more service modules 810 may coordinate with the network entity 105-e directly. In some other examples, the UE delegation service 815 may coordinate with the network entity 105-e such that the network entity 105-e is prepared for the forthcoming service configurations. That is, the UE delegation service 815 may determine the configurations for the wireless device 805 and the network entity 105-e at 855 by consulting with the network entity 105-e to obtain the status and configuration preferences of the network entity 105-e at 850. As such, the UE delegation service 815 may negotiate on behalf of the wireless device 805 to determine a service configuration for the wireless device 805 within the network. Therefore, the techniques of the present disclosure described herein with reference to FIG. 8 may reduce the signaling overhead on a Uu link between the wireless device 805 and the network entity 105-e thus resulting in a more efficient and reliable wireless communication system. Further descriptions of the techniques of the present disclosure may be described elsewhere herein with reference to FIGS. 9 through 11.

FIG. 9 shows an example of a process flow 900 that supports a UE delegation service in accordance with one or more aspects of the present disclosure. In some examples, the process flow 900 may implement or be implemented by the wireless communications system 100, the network architecture 200, and/or the wireless communications system 300. For example, the process flow 900 may include a wireless device 905 (e.g., a UE 115), a network entity 105-f, one or more service modules 910, a UE delegation service 915, and a subscription service 920, which may be examples of devices or services described herein with reference to FIGS. 1 through 3.

In the following description of the process flow 900, the operations between the wireless device 905, the network entity 105-f, the one or more service modules 910, the UE delegation service 915, and the subscription service 920, may be performed in different orders or at different times. Some operations may also be left out of the process flow 900, or other operations may be added. Although the wireless device 905, the network entity 105-f, the one or more service modules 910, the UE delegation service 915, and the subscription service 920 are shown performing the operations of the process flow 900, some aspects of some operations may also be performed by one or more other wireless devices.

In some examples, the UE delegation service 915 may initiate the generation of one or more service configurations for the wireless device 905 based on the UE delegation service 915 coordinating with the wireless device 905. Thus, at 925, the wireless device 905 and the UE delegation service 915 may communicate device status and configuration management information via an interface between the wireless device 905 and the UE delegation service 915. Further, at 930, the UE delegation service 915 may obtain, from the wireless device 905 (e.g., the first device), a service request message 932 that requests establishment of one or more services associated with the wireless device 905. That is, the UE delegation service 915 may obtain a list of the one or more service with which the wireless device 905 (e.g., the first device) is requesting to establish a service with. Further, the list may be a list of one or more service IDs to the UE delegation service 915 to indicate for the UE delegation service 915 to initiate the generation of a service configuration between the wireless device 905 and each respective service corresponding to the indicated one or more service IDs.

At 935, the UE delegation service 915 may discover the location of the one or more service modules 910 via one or more procedures of the wireless device 905 (e.g., UE 115 procedures) or directly from the wireless device 905. Thus, at 940, the UE delegation service 915 may receive subscription information from the selected services of the subscription service 920 (e.g., the services indicated via the list of service IDs at 930). In response, at 945, the UE delegation service 915 may output, to the one or more service modules 910, one or more service configuration request messages (e.g., such as the service configuration request message 345 described with reference to FIG. 3) based on the one or more service configuration request messages from the wireless device 905. That is, the UE delegation service 915 may transmit a service configuration request message to the corresponding one or more service modules 910 to negotiate a service configuration for the wireless device 905. At 950, the UE delegation service 915 may obtain, from the one or more service modules 910, a service configuration response message 952 of one or more service configuration response messages 952. For example, the UE delegation service 915 may obtain a respective service configuration response message 952 of the one or more service configuration response messages from a respective service module of the one or more service modules 910 that indicates a service profile of the respective service module 910, capability information of the respective service module 910, one or more configuration preferences for the respective service module 910, or any combination thereof.

In some examples, the UE delegation service 915 may also coordinate with the network entity 105-f to determine the service configurations for the wireless device 905. For example, at 955, as described with reference to FIG. 8, the UE delegation service 915 may output, to the network entity 105-f, a configuration preference request message (e.g., the service configuration preference request message 850) to request the status and configuration preferences of the network entity 105-f. In response, at 960, the UE delegation service 915 may obtain, from the network entity 105-f an indication of one or more configuration preferences (e.g., the indication of the one or more configuration preferences 860) for the service configuration.

Thus, at 970, the UE delegation service 915 may negotiate and determine the service configurations for the wireless device 905 based on the request from the one or more service modules 910 and the preferences of the network entity 105-f. In some examples, the UE delegation service 915 may refrain from coordinating with the network entity 105-f to determine the service configurations such that the one or more service modules 910 coordinate directly with the network entity 105-f. Further, the UE delegation service 915 may use the status and configuration preferences when determining the wireless device 905 and network entity 105-f configuration.

Further, at 970, the UE delegation service 915 may communicate one or more messages to negotiate one or more parameters of the service configuration for the wireless device 905 on the behalf of the wireless device 905. Additionally, or alternatively, the one or more parameters may be based on a service management message (e.g., the service management message 340 described herein with reference to FIG. 3), the one or more service configuration response messages 952 received at 950, the one or more configuration preferences from the network entity 105-f (e.g., the second device), or any combination thereof. Thus, at 975, the UE delegation service 915 may provide the respective service configurations for each respective service to the network entity 105-f and the wireless device 905. Further description of the UE delegation service 915 reducing the impact of over-the-air messaging when establishing service configurations in accordance with one or more aspects of the present disclosure may be described elsewhere herein with reference to FIGS. 10 and 11.

FIG. 10 shows an example of a process flow 1000 that supports a UE delegation service in accordance with one or more aspects of the present disclosure. In some examples, the process flow 1000 may implement or be implemented by the wireless communications system 100, the network architecture 200, and/or the wireless communications system 300. For example, the process flow 1000 may include a wireless device 1005 (e.g., a UE 115), a network entity 105-g, one or more service modules 1010, a UE delegation service 1015, and a subscription service 1020, which may be examples of devices or services described herein with reference to FIGS. 1 through 3.

In the following description of the process flow 1000, the operations between the wireless device 1005, the network entity 105-g, the one or more service modules 1010, the UE delegation service 1015, and the subscription service 1020, may be performed in different orders or at different times. Some operations may also be left out of the process flow 1000, or other operations may be added. Although the wireless device 1005, the network entity 105-g, the one or more service modules 1010, the UE delegation service 1015, and the subscription service 1020 are shown performing the operations of the process flow 1000, some aspects of some operations may also be performed by one or more other wireless devices.

At 1025, the wireless device 1005 and the UE delegation service 1015 may communicate device status and configuration management information via an interface between the wireless device 1005 and the UE delegation service 1015 that is described elsewhere herein. Further, at 1030, the UE delegation service 1015 may obtain, from the wireless device 1005 (e.g., a first device in a wireless network) a service request message 1032 (e.g., the service request message 932 described with reference to FIG. 9) that requests establishment of one or more services associated with the wireless device 1005. Further, the service request message may include a list of service IDs. That is, the wireless device 1005 may transmit a list of one or more service IDs to the UE delegation service 1015 to indicate for the UE delegation service 1015 to initiate the generation of a service configuration between the wireless device 1005 and each respective service corresponding to the indicated one or more service IDs

At 1035, in some examples, the wireless device 1005 may transmit a service request or establishment message to the one or more service modules 1010 to request a service establishment with each service indicated via the service request transmitted at 1030. In response, in some examples, at 1040, the one or more service modules 1010 and the subscription service 1020 may perform a subscription check. In some other examples, at 1045, the subscription service 1020 and the UE delegation service 1015 may perform the subscription check. Further, at 1050, the UE delegation service 1015 may output, to the one or more service modules 1010, a service configuration request message (e.g., the service configuration request message 345 described with reference to FIG. 3).

At 1055, the UE delegation service 1015 may obtain, from the one or more service modules 1010, one or more service configuration feasibility request messages 1058 (e.g., a service configuration feasibility enquiry). The UE delegation service 1015 may use the service configuration feasibility request message 1058 to check the feasibility of the requested configuration(s) for the wireless device 1005. The service configuration feasibility request message 1058 may be relatively important when the configuration of the wireless device 1005 is limited by the proprietary information of the wireless device 1005. Further, there may be multiple options included to converge or establish a service configuration quicker. Thus, in some examples, multiple iterations or a combination of different options and iterations of service establishments may be tested and performed to determine an efficient service configuration for the wireless device 1005.

In response, at 1060, the UE delegation service 1015 may output, to the one or more service modules 1010, one or more service configuration feasibility response messages 1062 that indicate whether the service configuration between a respective service module of the one or more service modules 1010 and the wireless device 1005 is feasible. The one or more service configuration feasibility response messages 1062 may indicate the feasibility of a service configuration based on a current state of the network, the preferences of the network entity 105-g, the availability of resources, or any combination thereof. At 1065, the UE delegation service 1015 may output, to the wireless device 1005, a device management message 1068 that indicates one or more ML models. Further, the device management message 1068 (e.g., a device management signal) may indicate relevant device management information (e.g., AI/ML models to use) to the wireless device 1005.

At 1070, the one or more service modules 1010 may transmit a service configuration request to the network entity 105-g. In some examples, the service configuration request message may indicate which to the network entity 105-g the service configuration feasibility information received by the one or more service modules 1010 at 1060. Additionally, or alternatively, the service configuration request may indicate which services of the services requested at 1030 the one or more service modules 1010 are able to provide to the wireless device 1005 based on the received service configuration feasibility information.

At 1075, the UE delegation service 1015 may obtain, from the network entity 105-g (e.g., a second device in the wireless network), a UE 115 configuration feasibility request message 1078 (e.g., a wireless device 1005 configuration feasibility request message). The UE delegation service 1015 may use the UE 115 configuration feasibility request message 1078 to determine the service configurations for the services requested at 1030. At 1080, the UE delegation service 1015 may, output, to the network entity 105-g, a UE 115 configuration feasibility response message 1082 (e.g., a wireless device 1005 configuration feasibility response message). The UE 115 configuration feasibility response message 1082 may indicate whether the service configuration between the network entity 105-g and the wireless device 1005 is feasible. Further, the information of the UE 115 configuration feasibility response message 1082 may be based on a current state of the network, a current state of the wireless device 1005, the preferences of the wireless device 1005, an availability of resources, or any combination thereof.

Therefore, in response, at 1085, the network entity 105-g may transmit a service configuration response to the one or more service modules 1010 to indicate whether the service configurations requested at 1070. Thus, at 1090, the network entity 105-g may provide the corresponding and feasible service configurations to the wireless device 1005 to establish the service between the wireless device 1005 and respective services that correspond to the one or more service modules 1010. Moreover, in some examples, the UE delegation service 1015 may communicate one or more messages to negotiate one or more parameters of the service configuration for the wireless device 1005 on the behalf of the wireless device 1005. Such parameters may be based on a service management message 340 described with reference to FIG. 3, the service request message (e.g., the service request message 932 described with reference to FIG. 9), the one or more service configuration feasibility response messages 1062, the UE 115 configuration feasibility response message 1082, or any combination thereof. Further, the wireless device 1005 and the network entity 105-g may update the UE delegation service 1015 with the configuration that the wireless device 1005 is finally configured with. Thus, the UE delegation service 1015 may maintain the current state and configuration of the wireless device 1005 and be an accurate mirror of the wireless device 1005. Therefore, the UE delegation service 1015 may be capable of providing accurate information about the wireless device 1005 to the network entity 105-g and the one or more service modules 1010. Further, such techniques may allow the network entity 105-g and the one or more service modules 1010 to refrain from querying the wireless device 1005 for the preferences of the wireless device 1005, thus reducing the quantity of over-the-air messaging and improving the efficiency and reliability of the wireless communications network. Further descriptions of improving the efficiency and reliability of the wireless communications network in accordance with the one or more aspects of the present disclosure may be described elsewhere herein with reference to FIG. 11.

FIG. 11 shows an example of a process flow 1100 that supports a UE delegation service in accordance with one or more aspects of the present disclosure. In some examples, the process flow 1100 may implement or be implemented by the wireless communications system 100, the network architecture 200, and/or the wireless communications system 300. For example, the process flow 1100 may include a wireless device 1105 (e.g., a UE 115), a network entity 105-h, one or more service modules 1110, a UE delegation service 1015, and a subscription service 1120, which may be examples of devices or services described herein with reference to FIGS. 1 through 3.

In the following description of the process flow 1100, the operations between the wireless device 1105, the network entity 105-h, the one or more service modules 1110, the UE delegation service 1115, and the subscription service 1120, may be performed in different orders or at different times. Some operations may also be left out of the process flow 1100, or other operations may be added. Although the wireless device 1105, the network entity 105-h, the one or more service modules 1110, the UE delegation service 1115, and the subscription service 1120 are shown performing the operations of the process flow 1100, some aspects of some operations may also be performed by one or more other wireless devices.

At 1125, the wireless device 1105 and the UE delegation service 1115 may communicate device status and configuration management information via an interface between the wireless device 1105 and the UE delegation service 1115 that is described elsewhere herein. Additionally, or alternatively, the wireless device 1105 and the UE delegation service 1115 may communicate one or messages (e.g., including the service management message 340) to convey the device status and configuration management information. Further, the one or more messages may be transmitted over time as updates are made to the wireless device 1105 and as the state of the wireless device 1105 changes. In some examples, the one or more device status and configuration management messages may configure alternative AI/ML model inference procedures that can be operated or executed without CPU limitations in the network. Therefore, at 1130, the UE delegation service 1115 may monitor the performance of the wireless device 1105 (e.g., a first device in a wireless network). For example, the UE delegation service 1115 may monitor the performance of the wireless device 1105 to determine the effectiveness and reliability of the current service configurations and to determine if a more efficient service configuration can be negotiated.

Thus, at 1135, the UE delegation service 1115 may transmit a first service report (e.g., a first report 1138) to the one or more service modules 1110 to indicate the performance of the wireless device 1105 and suggest a reconfiguration for the wireless device 1105. Further, at 1140, the UE delegation service 1115 may transmit a second service report (e.g., a second report 1142) that indicates the performance of the wireless device 1105 and to suggest a reconfiguration for the wireless device 1105.

Therefore, in some examples, at 1145, the UE delegation service 1115, the one or more service modules 1110, the network entity 105-h, or any combination thereof may perform a reconfiguration procedure. In some examples, the UE delegation service 1115 may obtain or output a reconfiguration message 1148 to reconfigure the service configuration on behalf of the wireless device 1105. Further, the UE delegation service 1115 may obtain or output the reconfiguration message 1148 based on the performance of the wireless device 1105 satisfying a performance threshold. Additionally, or alternatively, the reconfiguration procedure may be initiated by the one or more service modules 1110, the network entity 105-h, or the UE delegation service 1115 based on the performance of the wireless device 1105 monitored at 1130 and indicated via the first service report and the second service report.

Further, as part of the reconfiguration procedure the one or more service modules 1110 may send a configuration request message to the UE delegation service 1115. Thus, the UE delegation service 1115 may determine the configuration for the wireless device 1105 based on the service configuration request (e.g., the service configuration request message 345 described with reference to FIG. 3), the status of the network entity 105-h and the wireless device 1105, the configuration preferences of the network entity 105-h and the wireless device 1105, or any combination thereof. Thus, the UE delegation service 1115 may communicate one or more messages to renegotiate one or more parameters of the service configuration of the wireless device 1105 on the behalf of the wireless device 1105. Further, the one or more parameters may be based on the reconfiguration message 1148 and on the performance of the wireless device 1105 satisfying a performance threshold.

Following, the reconfiguration procedure, at 1150, the UE delegation service 1115 may provide the relevant device status and configuration management information within a device management signal that is described elsewhere herein. As such, in accordance with the techniques of the present disclosure, the UE delegation service 1115 may assist in reducing the quantity of over-the-air messaging to minimize the impact and delay on the Uu link between the wireless device 1105 and the network entity 105-h.

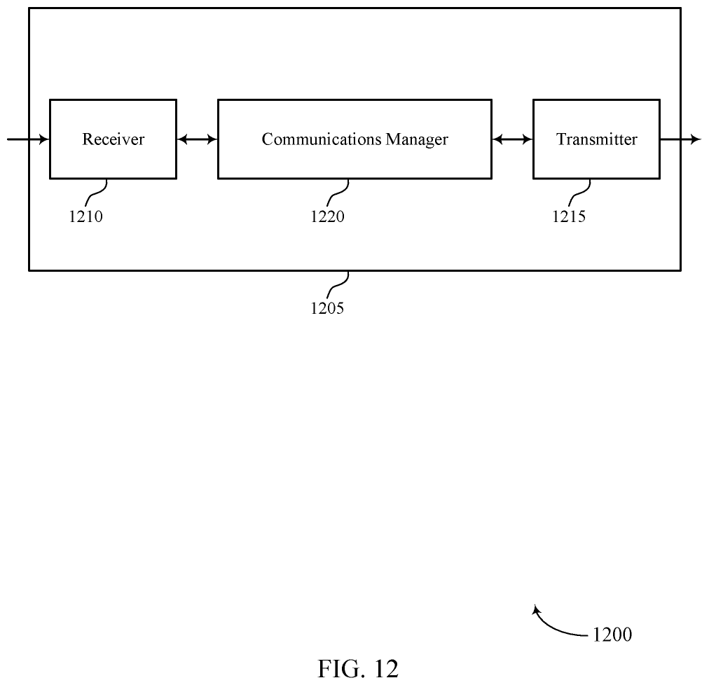

FIG. 12 shows a block diagram 1200 of a device 1205 that supports a UE delegation service in accordance with one or more aspects of the present disclosure. The device 1205 may be an example of aspects of a UE delegation service as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to, individually or collectively, support or enable the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to UE delegation service). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to UE delegation service). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of UE delegation service as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor. If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for obtaining a service management message authorizing the UE delegation service to negotiate a service configuration on behalf of a first device in a wireless network. The communications manager 1220 is capable of, configured to, or operable to support a means for communicating, with one or more service modules, on the behalf of the first device based on the service management message.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for a UE delegation service to reduce the quantity of over-the-air messaging to support a reduced latency and more efficient utilization of communication resources.

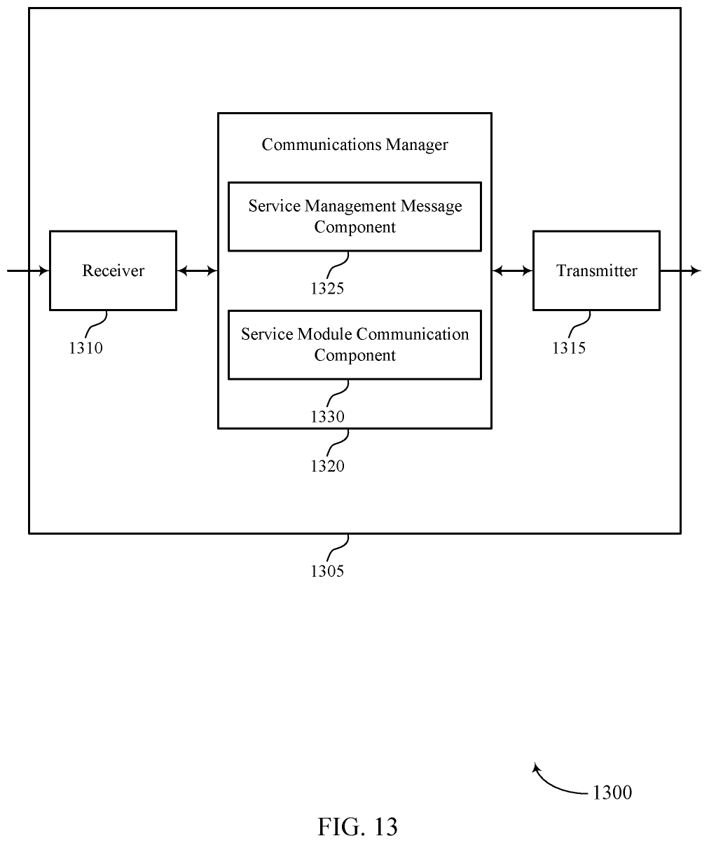

FIG. 13 shows a block diagram 1300 of a device 1305 that supports a UE delegation service in accordance with one or more aspects of the present disclosure. The device 1305 may be an example of aspects of a device 1205 or a UE delegation service as described herein. The device 1305 may include a receiver 1310, a transmitter 1315, and a communications manager 1320. The device 1305, or one or more components of the device 1305 (e.g., the receiver 1310, the transmitter 1315, and the communications manager 1320), may include at least one processor, which may be coupled with at least one memory, to support the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to UE delegation service). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to UE delegation service). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of UE delegation service as described herein. For example, the communications manager 1320 may include a service management message component 1325 a service module communication component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The service management message component 1325 is capable of, configured to, or operable to support a means for obtaining a service management message authorizing the UE delegation service to negotiate a service configuration on behalf of a first device in a wireless network. The service module communication component 1330 is capable of, configured to, or operable to support a means for communicating, with one or more service modules, on the behalf of the first device based on the service management message.

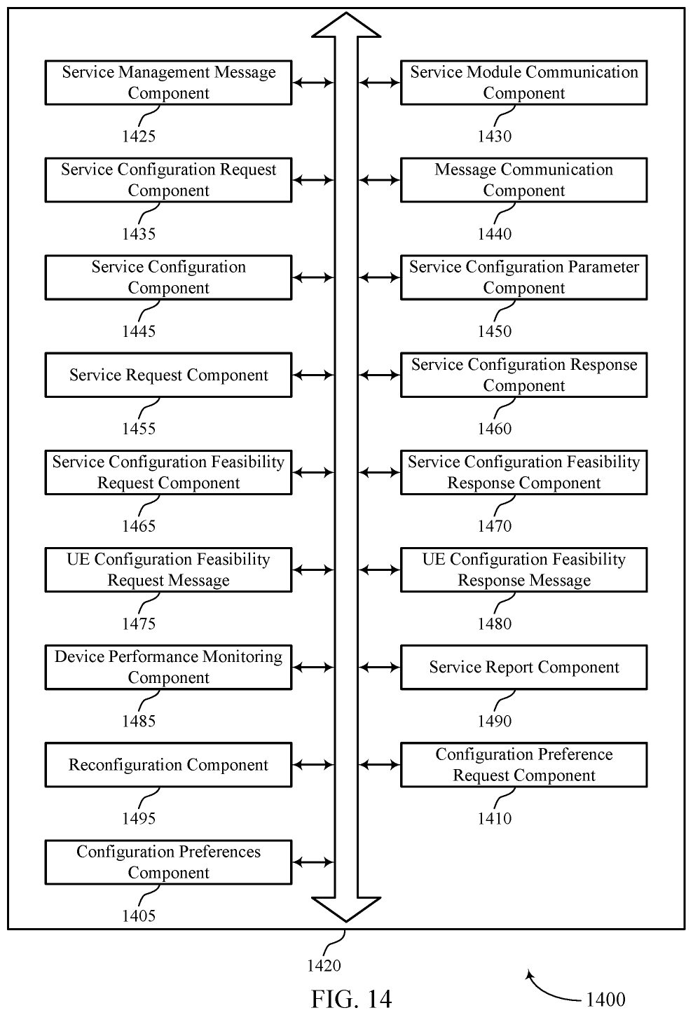

FIG. 14 shows a block diagram 1400 of a communications manager 1420 that supports a UE delegation service in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of UE delegation service as described herein. For example, the communications manager 1420 may include a service management message component 1425, a service module communication component 1430, a service configuration request component 1435, a message communication component 1440, a service configuration component 1445, a service configuration parameter component 1450, a service request component 1455, a service configuration response component 1460, a service configuration feasibility request component 1465, a service configuration feasibility response component 1470, a UE configuration feasibility request message 1475, a UE configuration feasibility response message 1480, a device performance monitoring component 1485, a service report component 1490, a reconfiguration component 1495, a configuration preference request component 1410, a configuration preferences component 1405, or any combination thereof. Each of these components, or components or subcomponents thereof (e.g., one or more processors, one or more memories), may communicate, directly or indirectly, with one another (e.g., via one or more buses).

The communications manager 1420 may support wireless communications in accordance with examples as disclosed herein. The service management message component 1425 is capable of, configured to, or operable to support a means for obtaining a service management message authorizing the UE delegation service to negotiate a service configuration on behalf of a first device in a wireless network. The service module communication component 1430 is capable of, configured to, or operable to support a means for communicating, with one or more service modules, on the behalf of the first device based on the service management message.

In some examples, the service management message component 1425 is capable of, configured to, or operable to support a means for obtaining, from the first device in the wireless network, the service management message, the service management message updating the UE delegation service with a status of the first device and one or more dynamic preferences of the first device.

In some examples, the service management message component 1425 is capable of, configured to, or operable to support a means for outputting, to the first device in the wireless network, the service management message, the service management message updating or affecting a status of the first device and one or more dynamic preferences of the first device based on communication with the one or more service modules.

In some examples, the service configuration request component 1435 is capable of, configured to, or operable to support a means for outputting, or obtaining, a service configuration request that requests an establishment of a service associated with the first device. In some examples, the service module communication component 1430 is capable of, configured to, or operable to support a means for communicating, with at least one service module of the one or more service modules, one or more service configuration messages to negotiate, with the at least one service module, the service configuration of the service for the first device based on the service configuration request, the service management message, or both.

In some examples, the message communication component 1440 is capable of, configured to, or operable to support a means for communicating one or more messages to negotiate one or more parameters of the service configuration. In some examples, the service configuration component 1445 is capable of, configured to, or operable to support a means for obtaining, from a second device in the wireless network, the service configuration based on the one or more messages, where the second device is a network entity of a radio access network.

In some examples, the service configuration parameter component 1450 is capable of, configured to, or operable to support a means for determining, at the UE delegation service, one or more parameters of the service configuration for the first device. In some examples, the service module communication component 1430 is capable of, configured to, or operable to support a means for communicating, with the one or more service modules, one or more messages that include the one or more parameters of the service configuration for the first device.

In some examples, the service configuration request component 1435 is capable of, configured to, or operable to support a means for obtaining, from at least one service module of the one or more service modules, a service configuration request. In some examples, the message communication component 1440 is capable of, configured to, or operable to support a means for communicating one or more messages to negotiate one or more parameters of the service configuration on the behalf of the first device based on the service management message, the service configuration request, or both.

In some examples, the configuration preference request component 1410 is capable of, configured to, or operable to support a means for outputting, to a second device in the wireless network, a configuration preference request message. In some examples, the configuration preferences component 1405 is capable of, configured to, or operable to support a means for obtaining, from the second device, an indication of one or more configuration preferences for the service configuration based on the configuration preference request message. In some examples, the message communication component 1440 is capable of, configured to, or operable to support a means for communicating the one or more messages to negotiate the one or more parameters of the service configuration on the behalf of the first device based on the service management message, the service configuration request, the one or more configuration preferences from the second device, or any combination thereof.

In some examples, the service request component 1455 is capable of, configured to, or operable to support a means for obtaining, from the first device, a service request message that requests establishment of one or more services associated with the first device. In some examples, the service configuration request component 1435 is capable of, configured to, or operable to support a means for outputting, to the one or more service modules, one or more service configuration request messages based on the one or more service configuration request messages from the first device. In some examples, the service configuration response component 1460 is capable of, configured to, or operable to support a means for obtaining, from the one or more service modules, one or more service configuration response messages. In some examples, the message communication component 1440 is capable of, configured to, or operable to support a means for communicating one or more messages to negotiate one or more parameters of the service configuration on the behalf of the first device based on the service management message, the one or more service configuration response messages, or both.

In some examples, the configuration preference request component 1410 is capable of, configured to, or operable to support a means for outputting, to a second device in the wireless network, a configuration preference request message. In some examples, the configuration preferences component 1405 is capable of, configured to, or operable to support a means for obtaining, from the second device, an indication of one or more configuration preferences for the service configuration. In some examples, the message communication component 1440 is capable of, configured to, or operable to support a means for communicating the one or more messages to negotiate the one or more parameters of the service configuration on the behalf of the first device based on the service management message, the one or more service configuration response messages, the one or more configuration preferences from the second device, or any combination thereof.

In some examples, the service request component 1455 is capable of, configured to, or operable to support a means for obtaining a list of the one or more services with which the first device is requesting to establish a service.

In some examples, the service configuration response component 1460 is capable of, configured to, or operable to support a means for obtaining a respective service configuration response message of the one or more service configuration response messages from a respective service module of the one or more service modules that indicates a service profile of the respective service module, capability information of the respective service module, one or more configuration preferences for the respective service module, or any combination thereof.

In some examples, the service configuration feasibility request component 1465 is capable of, configured to, or operable to support a means for obtaining, from the one or more service modules, one or more service configuration feasibility request messages. In some examples, the service configuration feasibility response component 1470 is capable of, configured to, or operable to support a means for outputting, to the one or more service modules, one or more service configuration feasibility response messages, the one or more service configuration feasibility response messages indicating whether the service configuration between a respective service module of the one or more service modules and the first device is feasible.

In some examples, the service request component 1455 is capable of, configured to, or operable to support a means for obtaining, from the first device, a service request message that requests establishment of one or more services associated with the first device. In some examples, the service configuration request component 1435 is capable of, configured to, or operable to support a means for outputting, to the one or more service modules, a service configuration request message. In some examples, the message communication component 1440 is capable of, configured to, or operable to support a means for communicating one or more messages to negotiate one or more parameters of the service configuration on the behalf of the first device based on the service request message.

In some examples, the message communication component 1440 is capable of, configured to, or operable to support a means for outputting, to the first device, a device management message indicating one or more machine learning models.

In some examples, the UE configuration feasibility request message 1475 is capable of, configured to, or operable to support a means for obtaining, from a second device in the wireless network, a UE configuration feasibility request message. In some examples, the UE configuration feasibility response message 1480 is capable of, configured to, or operable to support a means for outputting, to the second device, a UE configuration feasibility response message, the UE configuration feasibility response message indicating whether the service configuration between the second device and the first device is feasible.

In some examples, the one or more service modules may include a first service module and a second service module, and the device performance monitoring component 1485 is capable of, configured to, or operable to support a means for monitoring performance of the first device. In some examples, the service report component 1490 is capable of, configured to, or operable to support a means for outputting, to the one or more service modules, a first report based on the performance of the first device, a second report based on the performance of the first device, to a second device in the wireless network, or outputting both the first report and the second report, where the first report corresponds to the first service module and the second report corresponds to the second service module. In some examples, the reconfiguration component 1495 is capable of, configured to, or operable to support a means for outputting, or obtaining, a reconfiguration message to reconfigure the service configuration on the behalf of the first device, where the reconfiguration message is outputted, or obtained, based on the performance of the first device satisfying a performance threshold. In some examples, the message communication component 1440 is capable of, configured to, or operable to support a means for communicating one or more messages to renegotiate one or more parameters of the service configuration on the behalf of the first device based on the reconfiguration message and the performance of the first device satisfying the performance threshold.

In some examples, the first device may be one of a set of devices in the wireless network, and the service management message component 1425 is capable of, configured to, or operable to support a means for receiving a set of multiple service management message authorizing the UE delegation service to negotiate the service configuration on the behalf of the set of multiple devices.

In some examples, the service management message component 1425 is capable of, configured to, or operable to support a means for obtaining the service management message via a communication interface between the first device and the UE delegation service.

In some examples, the service management message component 1425 is capable of, configured to, or operable to support a means for obtaining, via a communication interface between the first device and the UE delegation service, device management information including a report of one or more statistics of the first device, information associated with one or more machine learning models, information associated with downloading the one or more machine learning models, or any combination thereof.

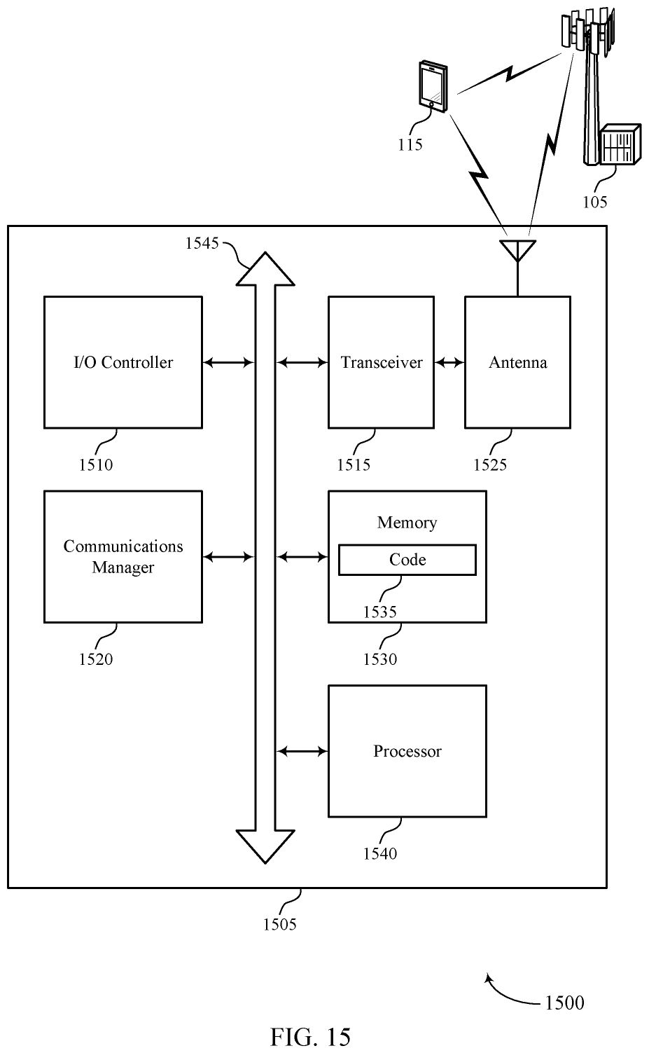

FIG. 15 shows a diagram of a system 1500 including a device 1505 that supports a UE delegation service in accordance with one or more aspects of the present disclosure. The device 1505 may be an example of or include the components of a device 1205, a device 1305, or a UE delegation service as described herein. The device 1505 may include components for bi-directional voice and data communications including components for transmitting and receiving communications, such as a communications manager 1520, an I/O controller 1510, a transceiver 1515, an antenna 1525, at least one memory 1530, code 1535, and at least one processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of one or more processors, such as the at least one processor 1540. In some cases, a user may interact with the device 1505 via the I/O controller 1510 or via hardware components controlled by the I/O controller 1510.

In some cases, the device 1505 may include a single antenna 1525. However, in some other cases, the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The at least one memory 1530 may include RAM and ROM. The at least one memory 1530 may store computer-readable, computer-executable code 1535 including instructions that, when executed by the at least one processor 1540, cause the device 1505 to perform various functions described herein. The code 1535 may be stored in a non-transitory computer-readable medium such as system memory or another type of memory. In some cases, the code 1535 may not be directly executable by the at least one processor 1540 but may cause a computer (e.g., when compiled and executed) to perform functions described herein. In some cases, the at least one memory 1530 may contain, among other things, a BIOS which may control basic hardware or software operation such as the interaction with peripheral components or devices.

The at least one processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1540 may be configured to operate a memory array using a memory controller. In some other cases, a memory controller may be integrated into the at least one processor 1540. The at least one processor 1540 may be configured to execute computer-readable instructions stored in a memory (e.g., the at least one memory 1530) to cause the device 1505 to perform various functions (e.g., functions or tasks supporting UE delegation service). For example, the device 1505 or a component of the device 1505 may include at least one processor 1540 and at least one memory 1530 coupled with or to the at least one processor 1540, the at least one processor 1540 and at least one memory 1530 configured to perform various functions described herein. In some examples, the at least one processor 1540 may include multiple processors and the at least one memory 1530 may include multiple memories. One or more of the multiple processors may be coupled with one or more of the multiple memories, which may, individually or collectively, be configured to perform various functions herein. In some examples, the at least one processor 1540 may be a component of a processing system, which may refer to a system (such as a series) of machines, circuitry (including, for example, one or both of processor circuitry (which may include the at least one processor 1540) and memory circuitry (which may include the at least one memory 1530)), or components, that receives or obtains inputs and processes the inputs to produce, generate, or obtain a set of outputs. The processing system may be configured to perform one or more of the functions described herein. For example, the at least one processor 1540 or a processing system including the at least one processor 1540 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1530 or otherwise, to perform one or more of the functions described herein.

The communications manager 1520 may support wireless communications in accordance with examples as disclosed herein. For example, the communications manager 1520 is capable of, configured to, or operable to support a means for obtaining a service management message authorizing the UE delegation service to negotiate a service configuration on behalf of a first device in a wireless network. The communications manager 1520 is capable of, configured to, or operable to support a means for communicating, with one or more service modules, on the behalf of the first device based on the service management message.

By including or configuring the communications manager 1520 in accordance with examples as described herein, the device 1505 may support techniques for a UE delegation service to reduce the quantity of over-the-air messaging to support a reduced latency and more efficient utilization of communication resources

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the at least one processor 1540, the at least one memory 1530, the code 1535, or any combination thereof. For example, the code 1535 may include instructions executable by the at least one processor 1540 to cause the device 1505 to perform various aspects of UE delegation service as described herein, or the at least one processor 1540 and the at least one memory 1530 may be otherwise configured to, individually or collectively, perform or support such operations.

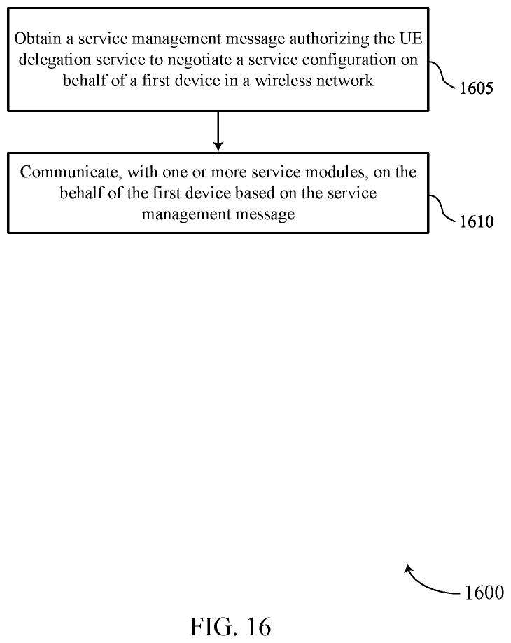

FIG. 16 shows a flowchart illustrating a method 1600 that supports a UE delegation service in accordance with one or more aspects of the present disclosure. The operations of the method 1600 may be implemented by a UE delegation service or its components as described herein. For example, the operations of the method 1600 may be performed by a UE delegation service as described with reference to FIGS. 1 through 15. In some examples, a UE delegation service may execute a set of instructions to control the functional elements of the UE delegation service to perform the described functions. Additionally, or alternatively, the UE delegation service may perform aspects of the described functions using special-purpose hardware.

At 1605, the method may include obtaining a service management message authorizing the UE delegation service to negotiate a service configuration on behalf of a first device in a wireless network. The operations of block 1605 may be performed in accordance with examples as disclosed herein. In some examples, aspects of the operations of 1605 may be performed by a service management message component 1425 as described with reference to FIG. 14. At 1610, the method may include communicating, with one or more service modules, on the behalf of the first device based on the service management message. The operations of block 1610 may be performed in accordance with examples as disclosed herein. In some examples, aspects of the operations of 1610 may be performed by a service module communication component 1430 as described with reference to FIG. 14.

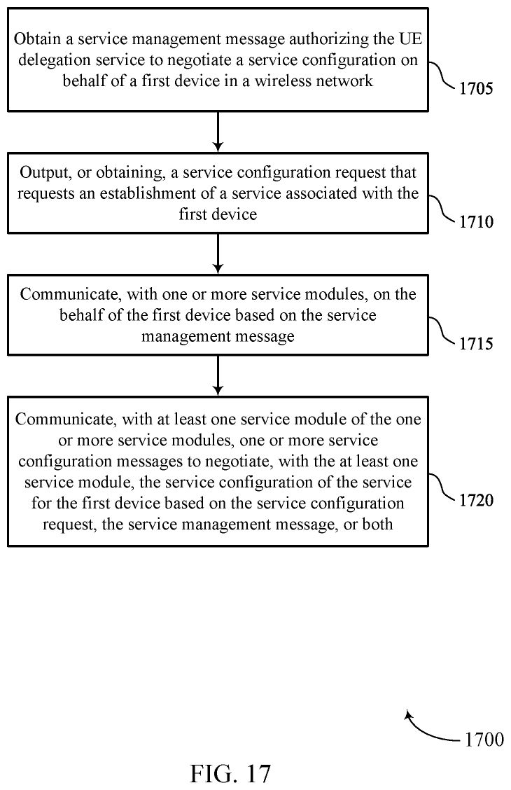

FIG. 17 shows a flowchart illustrating a method 1700 that supports user equipment delegation service in accordance with one or more aspects of the present disclosure. The operations of the method 1700 may be implemented by a UE delegation service or its components as described herein. For example, the operations of the method 1700 may be performed by a UE delegation service as described with reference to FIGS. 1 through 15. In some examples, a UE delegation service may execute a set of instructions to control the functional elements of the UE delegation service to perform the described functions. Additionally, or alternatively, the UE delegation service may perform aspects of the described functions using special-purpose hardware.

At 1705, the method may include obtaining a service management message authorizing the UE delegation service to negotiate a service configuration on behalf of a first device in a wireless network. The operations of 1705 may be performed in accordance with examples as disclosed herein. In some examples, aspects of the operations of 1705 may be performed by a service management message component 1425 as described with reference to FIG. 14.

At 1710, the method may include outputting, or obtaining, a service configuration request that requests an establishment of a service associated with the first device. The operations of 1710 may be performed in accordance with examples as disclosed herein. In some examples, aspects of the operations of 1710 may be performed by a service configuration request component 1435 as described with reference to FIG. 14.

At 1715, the method may include communicating, with one or more service modules, on the behalf of the first device based on the service management message. The operations of 1715 may be performed in accordance with examples as disclosed herein. In some examples, aspects of the operations of 1715 may be performed by a service module communication component 1430 as described with reference to FIG. 14.

At 1720, the method may include communicating, with at least one service module of the one or more service modules, one or more service configuration messages to negotiate, with the at least one service module, the service configuration of the service for the first device based on the service configuration request, the service management message, or both. The operations of 1720 may be performed in accordance with examples as disclosed herein. In some examples, aspects of the operations of 1720 may be performed by a service module communication component 1430 as described with reference to FIG. 14.

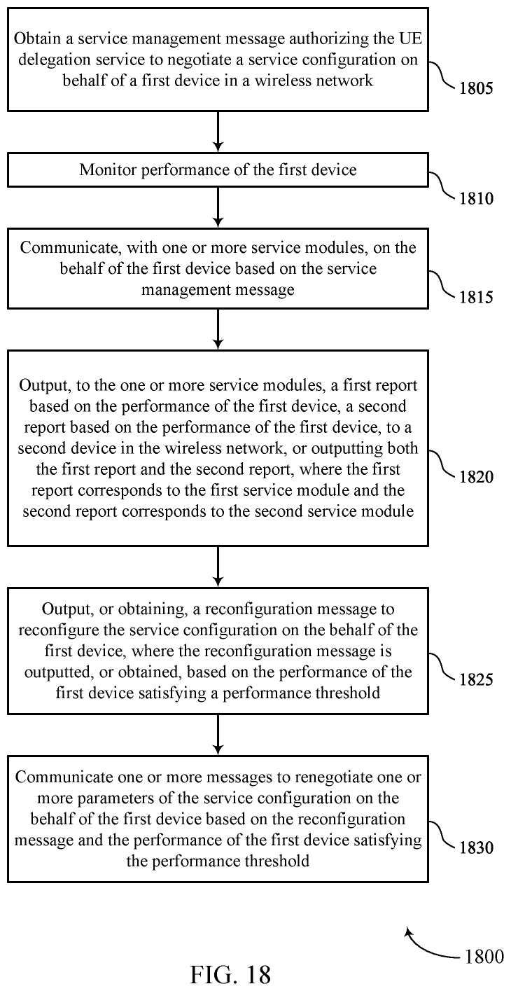

FIG. 18 shows a flowchart illustrating a method 1800 that supports user equipment delegation service in accordance with one or more aspects of the present disclosure. The operations of the method 1800 may be implemented by a UE delegation service or its components as described herein. For example, the operations of the method 1800 may be performed by a UE delegation service as described with reference to FIGS. 1 through 15. In some examples, a UE delegation service may execute a set of instructions to control the functional elements of the UE delegation service to perform the described functions. Additionally, or alternatively, the UE delegation service may perform aspects of the described functions using special-purpose hardware.

At 1805, the method may include obtaining a service management message authorizing the UE delegation service to negotiate a service configuration on behalf of a first device in a wireless network. The operations of 1805 may be performed in accordance with examples as disclosed herein. In some examples, aspects of the operations of 1805 may be performed by a service management message component 1425 as described with reference to FIG. 14.

At 1810, the method may include monitoring performance of the first device. The operations of 1810 may be performed in accordance with examples as disclosed herein. In some examples, aspects of the operations of 1810 may be performed by a device performance monitoring component 1485 as described with reference to FIG. 14.

At 1815, the method may include communicating, with one or more service modules, on the behalf of the first device based on the service management message. The operations of 1815 may be performed in accordance with examples as disclosed herein. In some examples, aspects of the operations of 1815 may be performed by a service module communication component 1430 as described with reference to FIG. 14.

At 1820, the method may include outputting, to the one or more service modules, a first report based on the performance of the first device, a second report based on the performance of the first device, to a second device in the wireless network, or outputting both the first report and the second report, where the first report corresponds to the first service module and the second report corresponds to the second service module. The operations of 1820 may be performed in accordance with examples as disclosed herein. In some examples, aspects of the operations of 1820 may be performed by a service report component 1490 as described with reference to FIG. 14.

At 1825, the method may include outputting, or obtaining, a reconfiguration message to reconfigure the service configuration on the behalf of the first device, where the reconfiguration message is outputted, or obtained, based on the performance of the first device satisfying a performance threshold. The operations of 1825 may be performed in accordance with examples as disclosed herein. In some examples, aspects of the operations of 1825 may be performed by a reconfiguration component 1495 as described with reference to FIG. 14.

At 1830, the method may include communicating one or more messages to renegotiate one or more parameters of the service configuration on the behalf of the first device based on the reconfiguration message and the performance of the first device satisfying the performance threshold. The operations of 1830 may be performed in accordance with examples as disclosed herein. In some examples, aspects of the operations of 1830 may be performed by a message communication component 1440 as described with reference to FIG. 14.

The following provides an overview of aspects of the present disclosure:

Aspect 1: A UE delegation service for wireless communications, comprising one or more memories, and one or more processors coupled with the one or more memories and configured to cause the UE delegation service to: obtain a service management message authorizing the UE delegation service to negotiate a service configuration on behalf of a first device in a wireless network; and communicate, with one or more service modules, on the behalf of the first device based at least in part on the service management message.

Aspect 2: The UE delegation service of aspect 21, wherein the one or more processors are further configured to cause the UE delegation service to: obtain, from the first device in the wireless network, the service management message, the service management message updating the UE delegation service with a status of the first device and one or more dynamic preferences of the first device.

Aspect 3: The UE delegation service of any of aspects 21 through 22, wherein the one or more processors are further configured to cause the UE delegation service to: output, to the first device in the wireless network, the service management message, the service management message updating or affecting a status of the first device and one or more dynamic preferences of the first device based at least in part on communication with the one or more service modules.

Aspect 4: The UE delegation service of any of aspects 21 through 23, wherein the one or more processors are further configured to cause the UE delegation service to: output, or obtain, a service configuration request that requests an establishment of a service associated with the first device; and communicate, with at least one service module of the one or more service modules, one or more service configuration messages to negotiate, with the at least one service module, the service configuration of the service for the first device based at least in part on the service configuration request, the service management message, or both.

Aspect 5: The UE delegation service of any of aspects 21 through 24, wherein the one or more processors are further configured to cause the UE delegation service to: communicate one or more messages to negotiate one or more parameters of the service configuration; and obtain, from a second device in the wireless network, the service configuration based at least in part on the one or more messages, wherein the second device is a network entity of a radio access network.

Aspect 6: The UE delegation service of any of aspects 21 through 25, wherein the one or more processors are further configured to cause the UE delegation service to: determine, at the UE delegation service, one or more parameters of the service configuration for the first device; and communicate, with the one or more service modules, one or more messages that include the one or more parameters of the service configuration for the first device.

Aspect 7: The UE delegation service of any of aspects 21 through 26, wherein the one or more processors are further configured to cause the UE delegation service to: obtain, from at least one service module of the one or more service modules, a service configuration request; and communicate one or more messages to negotiate one or more parameters of the service configuration on the behalf of the first device based at least in part on the service management message, the service configuration request, or both.

Aspect 8: The UE delegation service of aspect 27, wherein the one or more processors are further configured to cause the UE delegation service to: output, to a second device in the wireless network, a configuration preference request message; obtain, from the second device, an indication of one or more configuration preferences for the service configuration based at least in part on the configuration preference request message; and communicate the one or more messages to negotiate the one or more parameters of the service configuration on the behalf of the first device based at least in part on the service management message, the service configuration request, the one or more configuration preferences from the second device, or any combination thereof.

Aspect 9: The UE delegation service of any of aspects 21 through 28, wherein the one or more processors are further configured to cause the UE delegation service to: obtain, from the first device, a service request message that requests establishment of one or more services associated with the first device; output, to the one or more service modules, one or more service configuration request messages based at least in part on the one or more service configuration request messages from the first device; obtain, from the one or more service modules, one or more service configuration response messages; and communicate one or more messages to negotiate one or more parameters of the service configuration on the behalf of the first device based at least in part on the service management message, the one or more service configuration response messages, or both.

Aspect 10: The UE delegation service of aspect 29, wherein the one or more processors are further configured to cause the UE delegation service to: obtain, to a second device in the wireless network, a configuration preference request message; obtain, from the second device, an indication of one or more configuration preferences for the service configuration; and communicate the one or more messages to negotiate the one or more parameters of the service configuration on the behalf of the first device based at least in part on the service management message, the one or more service configuration response messages, the one or more configuration preferences from the second device, or any combination thereof.

Aspect 11: The UE delegation service of any of aspects 29 through 30, wherein, to obtain the service request message, the one or more processors are configured to cause the UE delegation service to: obtain a list of the one or more services with which the first device is requesting to establish a service.

Aspect 12: The UE delegation service of any of aspects 29 through 31, wherein, to obtain the one or more service configuration response messages, the one or more processors are configured to cause the UE delegation service to: obtain a respective service configuration response message of the one or more service configuration response messages from a respective service module of the one or more service modules that indicates a service profile of the respective service module, capability information of the respective service module, one or more configuration preferences for the respective service module, or any combination thereof.

Aspect 13: The UE delegation service of any of aspects 21 through 32, wherein the one or more processors are further configured to cause the UE delegation service to: obtain, from the one or more service modules, one or more service configuration feasibility request messages; and output, to the one or more service modules, one or more service configuration feasibility response messages, the one or more service configuration feasibility response messages indicating whether the service configuration between a respective service module of the one or more service modules and the first device is feasible.

Aspect 14: The UE delegation service of aspect 33, wherein the one or more processors are further configured to cause the UE delegation service to: obtain, from the first device, a service request message that requests establishment of one or more services associated with the first device; output, to the one or more service modules, a service configuration request message; and communicate one or more messages to negotiate one or more parameters of the service configuration on the behalf of the first device based at least in part on the service request message.

Aspect 15: The UE delegation service of any of aspects 33 through 34, wherein, to communicate the one or more messages, the one or more processors are configured to cause the UE delegation service to: output, to the first device, a device management message indicating one or more machine learning models.

Aspect 16: The UE delegation service of any of aspects 21 through 35, wherein the one or more processors are further configured to cause the UE delegation service to: obtain, from a second device in the wireless network, a UE configuration feasibility request message; and output, to the second device, a UE configuration feasibility response message, the UE configuration feasibility response message indicating whether the service configuration between the second device and the first device is feasible.

Aspect 17: The UE delegation service of any of aspects 21 through 36, wherein, the one or more service modules comprises a first service module and a second service module, and the one or more processors are configured to cause the UE delegation service to: monitor performance of the first device; output, to the one or more service modules, a first report based at least in part on the performance of the first device, a second report based at least in part on the performance of the first device, to a second device in the wireless network, or output both the first report and the second report, wherein the first report corresponds to the first service module and the second report corresponds to the second service module; output, or obtain, a reconfiguration message to reconfigure the service configuration on the behalf of the first device, wherein the reconfiguration message is outputted, or obtained, based at least in part on the performance of the first device satisfying a performance threshold; and communicate one or more messages to renegotiate one or more parameters of the service configuration on the behalf of the first device based at least in part on the reconfiguration message and the performance of the first device satisfying the performance threshold.

Aspect 18: The UE delegation service of any of aspects 21 through 37, the first device is one of a plurality of devices in the wireless network, and the one or more processors are configured to cause the UE delegation service to: receive a plurality of service management message authorizing the UE delegation service to negotiate the service configuration on the behalf of the plurality of devices.

Aspect 19: The UE delegation service of any of aspects 21 through 38, wherein to obtain the service management message, the one or more processors are configured to cause the UE delegation service to: obtain the service management message via a communication interface between the first device and the UE delegation service.

Aspect 20: The UE delegation service of any of aspects 21 through 39, wherein to obtain the service management message, the one or more processors are configured to cause the UE delegation service to: obtain, via a communication interface between the first device and the UE delegation service, device management information comprising a report of one or more statistics of the first device, information associated with one or more machine learning models, information associated with downloading the one or more machine learning models, or any combination thereof.

Aspect 21: A method for wireless communications by a UE delegation service, comprising: obtaining a service management message authorizing the UE delegation service to negotiate a service configuration on behalf of a first device in a wireless network; and communicating, with one or more service modules, on the behalf of the first device based at least in part on the service management message.

Aspect 22: The method of aspect 21, further comprising: obtaining, from the first device in the wireless network, the service management message, the service management message updating the UE delegation service with a status of the first device and one or more dynamic preferences of the first device.

Aspect 23: The method of any of aspects 21 through 22, further comprising: outputting, to the first device in the wireless network, the service management message, the service management message updating or affecting a status of the first device and one or more dynamic preferences of the first device based at least in part on communication with the one or more service modules.

Aspect 24: The method of any of aspects 21 through 23, further comprising: outputting, or obtaining, a service configuration request that requests an establishment of a service associated with the first device; and communicating, with at least one service module of the one or more service modules, one or more service configuration messages to negotiate, with the at least one service module, the service configuration of the service for the first device based at least in part on the service configuration request, the service management message, or both.

Aspect 25: The method of any of aspects 21 through 24, the communicating further comprising: communicating one or more messages to negotiate one or more parameters of the service configuration; and obtaining, from a second device in the wireless network, the service configuration based at least in part on the one or more messages, wherein the second device is a network entity of a radio access network.

Aspect 26: The method of any of aspects 21 through 25, further comprising: determining, at the UE delegation service, one or more parameters of the service configuration for the first device; and communicating, with the one or more service modules, one or more messages that include the one or more parameters of the service configuration for the first device.

Aspect 27: The method of any of aspects 21 through 26, further comprising: obtaining, from at least one service module of the one or more service modules, a service configuration request; and communicating one or more messages to negotiate one or more parameters of the service configuration on the behalf of the first device based at least in part on the service management message, the service configuration request, or both.

Aspect 28: The method of aspect 27, further comprising: outputting, to a second device in the wireless network, a configuration preference request message; obtaining, from the second device, an indication of one or more configuration preferences for the service configuration based at least in part on the configuration preference request message; and communicating the one or more messages to negotiate the one or more parameters of the service configuration on the behalf of the first device based at least in part on the service management message, the service configuration request, the one or more configuration preferences from the second device, or any combination thereof.

Aspect 29: The method of any of aspects 21 through 28, further comprising: obtaining, from the first device, a service request message that requests establishment of one or more services associated with the first device; outputting, to the one or more service modules, one or more service configuration request messages based at least in part on the one or more service configuration request messages from the first device; obtaining, from the one or more service modules, one or more service configuration response messages; and communicating one or more messages to negotiate one or more parameters of the service configuration on the behalf of the first device based at least in part on the service management message, the one or more service configuration response messages, or both.

Aspect 30: The method of aspect 29, further comprising: outputting, to a second device in the wireless network, a configuration preference request message; obtaining, from the second device, an indication of one or more configuration preferences for the service configuration; and communicating the one or more messages to negotiate the one or more parameters of the service configuration on the behalf of the first device based at least in part on the service management message, the one or more service configuration response messages, the one or more configuration preferences from the second device, or any combination thereof.

Aspect 31: The method of any of aspects 29 through 30, the obtaining of the service request message comprising: obtaining a list of the one or more services with which the first device is requesting to establish a service.

Aspect 32: The method of any of aspects 29 through 31, the obtaining of the one or more service configuration response messages comprising: obtaining a respective service configuration response message of the one or more service configuration response messages from a respective service module of the one or more service modules that indicates a service profile of the respective service module, capability information of the respective service module, one or more configuration preferences for the respective service module, or any combination thereof.

Aspect 33: The method of any of aspects 21 through 32, further comprising: obtaining, from the one or more service modules, one or more service configuration feasibility request messages; and outputting, to the one or more service modules, one or more service configuration feasibility response messages, the one or more service configuration feasibility response messages indicating whether the service configuration between a respective service module of the one or more service modules and the first device is feasible.

Aspect 34: The method of aspect 33, further comprising: obtaining, from the first device, a service request message that requests establishment of one or more services associated with the first device; outputting, to the one or more service modules, a service configuration request message; and communicating one or more messages to negotiate one or more parameters of the service configuration on the behalf of the first device based at least in part on the service request message.

Aspect 35: The method of any of aspects 33 through 34, the communicating of the one or more messages comprising: outputting, to the first device, a device management message indicating one or more machine learning models.

Aspect 36: The method of any of aspects 21 through 35, further comprising: obtaining, from a second device in the wireless network, a UE configuration feasibility request message; and outputting, to the second device, a UE configuration feasibility response message, the UE configuration feasibility response message indicating whether the service configuration between the second device and the first device is feasible.

Aspect 37: The method of any of aspects 21 through 36, the one or more service modules comprising a first service module and a second service module, and the method further comprising: monitoring performance of the first device; outputting, to the one or more service modules, a first report based at least in part on the performance of the first device, a second report based at least in part on the performance of the first device, to a second device in the wireless network, or outputting both the first report and the second report, wherein the first report corresponds to the first service module and the second report corresponds to the second service module; outputting, or obtaining, a reconfiguration message to reconfigure the service configuration on the behalf of the first device, wherein the reconfiguration message is outputted, or obtained, based at least in part on the performance of the first device satisfying a performance threshold; and communicating one or more messages to renegotiate one or more parameters of the service configuration on the behalf of the first device based at least in part on the reconfiguration message and the performance of the first device satisfying the performance threshold.

Aspect 38: The method of any of aspects 21 through 37, the first device is one of a plurality of devices in the wireless network, and the method further comprising: receiving a plurality of service management message authorizing the UE delegation service to negotiate the service configuration on the behalf of the plurality of devices.

Aspect 39: The method of any of aspects 21 through 38, the obtaining of the service management message comprising: obtaining the service management message via a communication interface between the first device and the UE delegation service.

Aspect 40: The method of any of aspects 21 through 39, the obtaining of the service management message comprising: obtaining, via a communication interface between the first device and the UE delegation service, device management information comprising a report of one or more statistics of the first device, information associated with one or more machine learning models, information associated with downloading the one or more machine learning models, or any combination thereof.

Aspect 41: A UE delegation service for wireless communications, comprising at least one means for performing a method of any of aspects 21 through 40.

Aspect 42: A non-transitory computer-readable medium storing code for wireless communications, the code comprising instructions executable by one or more processors to perform a method of any of aspects 21 through 40.

Aspect 47: A user equipment (UE) delegation service comprising: a processing system that includes processor circuitry and memory circuitry that stores code and is coupled with the processor circuitry, the processing system configured to cause the UE to perform a method of any of aspects 21 through 40.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication by a user equipment (UE) delegation service, comprising:
one or more memories; and
one or more processors coupled with the one or more memories and configured to cause the UE delegation service to:
obtain a service management message that authorizes the UE delegation service to negotiate a service configuration on behalf of a first device in a wireless network; and
communicate, with one or more service modules, on behalf of the first device based at least in part on the service management message.

2. The apparatus of claim 1, wherein the one or more processors are further configured to cause the UE delegation service to:
obtain, from the first device in the wireless network, the service management message, wherein the service management message updates the UE delegation service with a status of the first device and one or more dynamic preferences of the first device.

3. The apparatus of claim 1, wherein the one or more processors are further configured to cause the UE delegation service to:
output, to the first device in the wireless network, the service management message, wherein the service management message updates or affects a status of the first device and one or more dynamic preferences of the first device based at least in part on communication with the one or more service modules.

4. The apparatus of claim 1, wherein the one or more processors are further configured to cause the UE delegation service to:
output, or obtain, a service configuration request that requests an establishment of a service associated with the first device; and
communicate, with at least one service module of the one or more service modules, one or more service configuration messages to negotiate, with the at least one service module, the service configuration of the service for the first device based at least in part on the service configuration request, the service management message, or both.

5. The apparatus of claim 1, wherein the one or more processors are further configured to cause the UE delegation service to:
communicate one or more messages to negotiate one or more parameters of the service configuration; and
obtain, from a second device in the wireless network, the service configuration based at least in part on the one or more messages, wherein the second device is a network entity of a radio access network.

6. The apparatus of claim 1, wherein the one or more processors are further configured to cause the UE delegation service to:
determine, at the UE delegation service, one or more parameters of the service configuration for the first device; and
communicate, with the one or more service modules, one or more messages that include the one or more parameters of the service configuration for the first device.

7. The apparatus of claim 1, wherein the one or more processors are further configured to cause the UE delegation service to:
obtain, from at least one service module of the one or more service modules, a service configuration request; and
communicate one or more messages to negotiate one or more parameters of the service configuration on the behalf of the first device based at least in part on the service management message, the service configuration request, or both.

8. The apparatus of claim 7, wherein the one or more processors are further configured to cause the UE delegation service to:
output, to a second device in the wireless network, a configuration preference request message;
obtain, from the second device, an indication of one or more configuration preferences for the service configuration based at least in part on the configuration preference request message; and
communicate the one or more messages to negotiate the one or more parameters of the service configuration on behalf of the first device based at least in part on the service management message, the service configuration request, the one or more configuration preferences from the second device, or any combination thereof.

9. The apparatus of claim 1, wherein the one or more processors are further configured to cause the UE delegation service to:
obtain, from the first device, a service request message that requests establishment of one or more services associated with the first device;
output, to the one or more service modules, one or more service configuration request messages based at least in part on the one or more service configuration request messages from the first device;
obtain, from the one or more service modules, one or more service configuration response messages; and
communicate one or more messages to negotiate one or more parameters of the service configuration on behalf of the first device based at least in part on the service management message, the one or more service configuration response messages, or both.

10. The apparatus of claim 9, wherein the one or more processors are further configured to cause the UE delegation service to:
output, to a second device in the wireless network, a configuration preference request message;
obtain, from the second device, an indication of one or more configuration preferences for the service configuration; and
communicate the one or more messages to negotiate the one or more parameters of the service configuration on behalf of the first device based at least in part on the service management message, the one or more service configuration response messages, the one or more configuration preferences from the second device, or any combination thereof.

11. The apparatus of claim 9, wherein, to obtain the service request message, the one or more processors are configured to cause the UE delegation service to:
obtain a list of the one or more services with which the first device requests to establish a service.

12. The apparatus of claim 9, wherein, to obtain the one or more service configuration response messages, the one or more processors are configured to cause the UE delegation service to:
obtain a first service configuration response message of the one or more service configuration response messages from a first service module of the one or more service modules that indicates a service profile of the first service module, capability information of the first service module, one or more configuration preferences for the first service module, or any combination thereof.

13. The apparatus of claim 1, wherein the one or more processors are further configured to cause the UE delegation service to:
obtain, from the one or more service modules, one or more service configuration feasibility request messages; and
output, to the one or more service modules, one or more service configuration feasibility response messages, wherein the one or more service configuration feasibility response messages indicate whether the service configuration between a respective service module of the one or more service modules and the first device is feasible.

14. The apparatus of claim 13, wherein the one or more processors are further configured to cause the UE delegation service to:
obtain, from the first device, a service request message that requests establishment of one or more services associated with the first device;
output, to the one or more service modules, a service configuration request message; and
communicate one or more messages to negotiate one or more parameters of the service configuration on behalf of the first device based at least in part on the service request message.

15. The apparatus of claim 13, wherein, to communicate the one or more messages, the one or more processors are configured to cause the UE delegation service to:
output, to the first device, a device management message that indicates one or more machine learning models.

16. The apparatus of claim 1, wherein the one or more processors are further configured to cause the UE delegation service to:
obtain, from a second device in the wireless network, a UE configuration feasibility request message; and
output, to the second device, a UE configuration feasibility response message, wherein the UE configuration feasibility response message indicates whether the service configuration between the second device and the first device is feasible.

17. The apparatus of claim 1, wherein, the one or more service modules comprises a first service module and a second service module, and the one or more processors are configured to cause the UE delegation service to:
monitor performance of the first device;
output, to the one or more service modules, a first report based at least in part on the performance of the first device, a second report based at least in part on the performance of the first device, to a second device in the wireless network, or output both the first report and the second report, wherein the first report corresponds to the first service module and the second report corresponds to the second service module;
output, or obtain, a reconfiguration message to reconfigure the service configuration on behalf of the first device, wherein the reconfiguration message is outputted, or obtained, based at least in part on a performance threshold that is satisfied by the performance of the first device; and
communicate one or more messages to renegotiate one or more parameters of the service configuration on behalf of the first device based at least in part on the reconfiguration message and on the performance threshold that is satisfied by the performance of the first device.

18. The apparatus of claim 1, the first device is one of a plurality of devices in the wireless network, and the one or more processors are configured to cause the UE delegation service to:
receive a plurality of service management messages that authorize the UE delegation service to negotiate the service configuration on behalf of the plurality of devices.

19. A method for wireless communications by a user equipment (UE) delegation service, comprising:
obtaining a service management message authorizing the UE delegation service to negotiate a service configuration on behalf of a first device in a wireless network; and
communicating, with one or more service modules, on the behalf of the first device based at least in part on the service management message.

20. A non-transitory computer-readable medium storing code for wireless communications, the code comprising instructions executable by one or more processors to cause a user equipment (UE) delegation service to:
obtain a service management message authorizing a UE delegation service to negotiate a service configuration on behalf of a first device in a wireless network; and
communicate, with one or more service modules, on the behalf of the first device based at least in part on the service management message.
